(19) United States
(12) Patent Application Publication
(10) Pub. No.: US 2023/0351007 A1
(43) Pub. Date: Nov. 2, 2023

(54) MULTI-ADMIN VERIFICATION FOR IMPROVED SECURITY OF DATA STORES

(71) Applicant: NetApp, Inc., San Jose, CA (US)

(72) Inventors: John DeGraaf, Cranberrry Township, PA (US); Albert Straub, Pittsburgh, PA (US); Shashidhar Gudipalli, Cedar Park, TX (US); Vladislav Voinov, Sewickley, PA (US)

(21) Appl. No.: 18/304,950

(22) Filed: Apr. 21, 2023

Related U.S. Application Data
(63) Continuation-in-part of application No. 18/053,126, filed on Nov. 7, 2022.
(60) Provisional application No. 63/363,884, filed on Apr. 29, 2022.

(51) Int. Cl. G06F 21/45; G06F 21/62; G06F 21/40

(52) U.S. Cl. CPC G06F 21/45; G06F 21/6218; G06F 21/40

(57) ABSTRACT

Systems/techniques that facilitate multi-admin verification (MAV) for improved security of data stores are provided. In various embodiments, auto-execution of electronic requests may be facilitated. For example, an electronic approval of an electronic request may be received from an approver credential. A determination can be made that the electronic approval is a final electronic approval that causes a threshold number of valid electronic approvals for placing the electronic request in an approved state to be met. The electronic request is marked as being in the approved state in response to determining that the electronic approval is the final electronic approval. The electronic request is executed automatically after the electronic request has entered the approved state when the electronic request has been designated for auto-execution.

### CROSS-REFERENCE TO RELATED APPLICATIONS

This application is a continuation-in-part application of U.S. patent application Ser. No. 18/053,126, filed Nov. 7, 2022, which claims priority to U.S. Provisional Application No. 63/363,884, filed on Apr. 29, 2022, each of which is incorporated herein by reference in its entirety.

### TECHNICAL FIELD

The subject disclosure relates to data stores, and more specifically to multi-admin verification for improved security of data stores.

### BACKGROUND

A data store can electronically record data objects for and/or on behalf of a client. Various data operations can be electronically performed on such data objects in and/or via the data store. To help prevent unauthorized entities from performing such data operations on the data objects, the data store can implement role-based access control (RBAC) techniques and/or multi-factor authentication (MFA) techniques. Unfortunately, RBAC techniques and MFA techniques leave significant gaps in the security of the data store.

Systems and/or techniques that can address one or more of these technical problems (e.g., that can plug the security gaps left by RBAC and/or MFA) can be desirable.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, devices, systems, computer-implemented methods, apparatus and/or computer program products that can facilitate multi-admin verification for improved security of data stores are described.

According to one or more embodiments, a system is provided. In various aspects, the system can comprise a processor that can execute computer-executable components stored in a computer-readable memory. In various instances, the computer-executable components can comprise an access component that can access an electronic request associated with a data store and that can also access an electronic approval of the electronic request. In various cases, the electronic request can indicate a data object in the data store and can indicate a data operation to be performed on the data object. In various aspects, the electronic request can be issued by a first credential, and the electronic approval can be issued by a second credential. In various instances, the computer-executable components can further comprise a rule component that can identify a multi-admin verification rule that protects the data object from the data operation. In various cases, the multi-admin verification rule can specify a set of approver credentials that are authorized to electronically approve the electronic request, and the multi-admin verification rule can specify a threshold number of distinct electronic approvals issued by respective ones of the set of approver credentials that are required for the electronic request to be placed in an approved state. In various aspects, the computer-executable components can further comprise an approval component that can compare the second credential to both the set of approver credentials and the first credential. In various instances, in response to a determination that the second credential is within the set of approver credentials and does not match the first credential, the approval component can accept the electronic approval as valid and can increment an approval counter that is associated with the electronic request. In various cases, in response to a determination that the second credential matches the first credential, notwithstanding that the second credential is within the set of approver credentials, the approval component can reject the electronic approval as invalid and can refrain from incrementing the approval counter.

According to one or more embodiments, a system is provided. In various aspects, the system can comprise a processor that can execute computer-executable components stored in a computer-readable memory. In various aspects, the computer-executable components can comprise an access component that can access an electronic request associated with a data store and can access an electronic approval of the electronic request. In various instances, the electronic request can indicate a data object in the data store and a data operation to be performed on the data object. In various cases, the electronic request can be issued at a first time, and the electronic approval can be issued by a credential at a second time. In various aspects, the computer-executable components can further comprise a rule component that can identify a multi-admin verification rule that protects the data object from the data operation. In various instances, the multi-admin verification rule can specify a set of approver credentials that are authorized to electronically approve the electronic request, and the multi-admin verification rule can further specify a threshold number of distinct electronic approvals issued by respective ones of the set of approver credentials that are required for the electronic request to be placed in an approved state. In various cases, the multi-admin verification rule can further specify a first expiration timespan of the electronic request. In various aspects, the computer-executable components can further comprise an approval component that can compare the credential to the set of approver credentials and that can compare the first time to the second time. In various instances, in response to a determination that the credential is within the set of approver credentials and that a difference between the first time and the second time does not exceed the first expiration timespan, the approval component can accept the electronic approval as valid and can increment an approval counter that is associated with the electronic request. In various cases, in response to a determination that the difference between the first time and the second time exceeds the first expiration timespan, notwithstanding that the credential is within the set of approver credentials, the approval component can reject the electronic approval as invalid and can refrain from incrementing the approval counter.

According to one or more embodiments, a system is provided. In various aspects, the system can comprise a processor that can execute computer-executable components stored in a computer-readable memory. In various instances, the computer-executable components can comprise an access component that can access an electronic request associated with a data store and that can access an electronic approval of the electronic request. In various cases, the electronic request can indicate a first multi-admin verification rule that governs the data store, and can further indicate an edit to be performed on the first multi-admin verification rule. In various aspects, the electronic approval can be issued by a credential. In various instances, the computer-executable components can further comprise a rule component that can identify a second multi-admin verification rule that protects the first multi-admin verification rule from the edit. In various cases, the second multi-admin verification rule can specify a set of approver credentials that are authorized to electronically approve the electronic request, and can further specify a threshold number of distinct electronic approvals issued by respective ones of the set of approver credentials that are required for the electronic request to be placed in an approved state. In various aspects, the computer-executable components can further comprise an approval component that can compare the credential to the set of approver credentials. In various instances, in response to a determination that the credential is within the set of approver credentials, the approval component can accept the electronic approval as valid and can increment an approval counter that is associated with the electronic request. In various cases, in response to a determination that the credential is not within the set of approver credentials, the approval component can reject the electronic approval as invalid and can refrain from incrementing the approval counter.

According to one or more embodiments, a system is provided. In various aspects, the system can comprise a processor that can execute computer-executable components stored in a computer-readable memory. In various instances, the computer-executable components can comprise an access component that can access an electronic request associated with a data store and that can access an electronic approval of the electronic request. In various cases, the electronic request can indicate a data object in the data store and a data operation to be performed on the data object. In various aspects, the electronic approval can be issued by a credential. In various instances, the computer-executable components can further comprise a rule component that can identify a multi-admin verification rule that protects the data object from the data operation. In various cases, the multi-admin verification rule can specify a first set of approver credentials that are authorized to electronically approve the electronic request and that are associated with a first security clearance level, can specify a second set of approver credentials that are authorized to electronically approve the electronic request and that are associated with a second security clearance level that is different from the first security clearance level, can specify a first threshold number of distinct electronic approvals issued by respective ones of the first set of approver credentials that are required for the electronic request to be placed in an approved state, and/or can specify a second threshold number of distinct electronic approvals issued by respective ones of the second set of approver credentials that are required for the electronic request to be placed in the approved state. In various aspects, the computer-executable components can further comprise an approval component that can compare the credential to both the first set of approver credentials and the second set of approver credentials. In various instances, in response to a determination that the credential is within the first set of approver credentials, the approval component can accept the electronic approval as valid and can increment a first approval counter that is associated with the electronic request. In various cases, in response to a determination that the credential is within the second set of approver credentials, the approval component can accept the electronic approval as valid and can increment a second approval counter that is associated with the electronic request. In various aspects, in response to a determination that the credential is in neither the first set of approver credentials nor the second set of approver credentials, the approval component can reject the electronic approval as invalid and can refrain from incrementing the first approval counter and the second approval counter.

According to one or more embodiments, a system is provided. In various aspects, the system can comprise a processor that can execute computer-executable components stored in a computer-readable memory. In various instances, the computer-executable components can comprise an access component that can access an electronic request associated with a data store and that can access an electronic execution command of the electronic request. In various cases, the electronic request can indicate a data object in the data store and a data operation to be performed on the data object. In various aspects, the electronic request can be issued by a first credential, can be in an approved state, and/or can have been placed in the approved state due to one or more valid electronic approvals respectively issued by one or more second credentials. In various aspects, the electronic execution command can be issued by a third credential. In various instances, the computer-executable components can further comprise a rule component that can identify a multi-admin verification rule that protects the data object from the data operation. In various cases, the multi-admin verification rule can specify a set of executor credentials that are authorized to electronically execute the electronic request once the electronic request is placed in the approved state. In various aspects, the computer-executable components can further comprise an execution component that can compare the third credential to the set of executor credentials, to the first credential, and/or to the one or more second credentials. In various instances, in response to a determination that the third credential is within the set of executor credentials and matches neither the first credential nor any of the one or more second credentials, the execution component can accept the electronic execution command as valid and can execute the electronic request, thereby applying the data operation to the data object. In various cases, in response to a determination that the third credential matches the first credential or any one of the one or more second credentials, notwithstanding that the third credential is within the set of executor credentials, the execution component can reject the electronic execution command as invalid and can refrain from executing the electronic request.

According to one or more embodiments, the above-described systems can be implemented as computer-implemented methods and/or as computer program products.

### DESCRIPTION OF THE DRAWINGS

FIG. 1 illustrates a block diagram of an example, non-limiting system that facilitates multi-admin verification for improved security of data stores in accordance with one or more embodiments described herein.

FIG. 2 illustrates an example, non-limiting block diagram of a data store in accordance with one or more embodiments described herein.

FIG. 3 illustrates an example, non-limiting block diagram of an electronic request associated with a data store in accordance with one or more embodiments described herein.

FIG. 4 illustrates a block diagram of an example, non-limiting system including a multi-admin verification rule that facilitates multi-admin verification for improved security of data stores in accordance with one or more embodiments described herein.

FIG. 5 illustrates an example, non-limiting block diagram of a multi-admin verification rule in accordance with one or more embodiments described herein.

FIG. 6 illustrates a block diagram of an example, non-limiting system including a set of electronic approvals, an approval counter, and/or an approval message that facilitates multi-admin verification for improved security of data stores in accordance with one or more embodiments described herein.

FIG. 7 illustrates an example, non-limiting block diagram of a set of electronic approvals in accordance with one or more embodiments described herein.

FIGS. 8-12 illustrate flow diagrams of example, non-limiting computer-implemented methods that facilitate approval of an electronic request according to multi-admin verification for improved security of data stores in accordance with one or more embodiments described herein.

FIG. 13 illustrates an example, non-limiting block diagram of a multi-tiered set of approver credentials in accordance with one or more embodiments described herein.

FIG. 14 illustrates a block diagram of an example, non-limiting system including a set of electronic execution commands, an execution counter, and/or an execution message that facilitates multi-admin verification for improved security of data stores in accordance with one or more embodiments described herein.

FIG. 15 illustrates an example, non-limiting block diagram of a set of electronic execution commands in accordance with one or more embodiments described herein.

FIGS. 16-21 illustrate flow diagrams of example, non-limiting computer-implemented methods that facilitate execution of an electronic request according to multi-admin verification for improved security of data stores in accordance with one or more embodiments described herein.

FIG. 22 illustrates a block diagram of an example, non-limiting system 2200 for automatically executing an electronic request once the electronic request has entered the approved state in accordance with one or more embodiments described herein.

FIG. 23 illustrates a flow diagram of an example, non-limiting computer-implemented method for facilitating automatically executing an electronic request in accordance with one or more embodiments described herein.

FIG. 24 illustrates a flow diagram of an example, non-limiting computer-implemented method for facilitating auto-execution of an electronic request in accordance with one or more embodiments described herein.

FIG. 25 illustrates a flow diagram of an example, non-limiting computer-implemented method for facilitating auto-execution of an electronic request in accordance with one or more embodiments described herein.

FIG. 26 illustrates a flow diagram of an example, non-limiting computer-implemented method for facilitating auto-execution of an electronic request in accordance with one or more embodiments described herein.

FIG. 27 illustrates a block diagram of an example, non-limiting operating environment in which one or more embodiments described herein can be facilitated.

FIG. 28 illustrates an example networking environment operable to execute various implementations described herein.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

A data store (e.g., an object store, a file store, a block store) can electronically record data objects (e.g., files, documents, scripts, programs, applications) for and/or on behalf of a client (e.g., a client that is utilizing the data store as a storage service/platform). Various data operations (e.g., downloading, copying, deleting, editing, manipulating, searching, encrypting) can be electronically performed on such data objects in and/or via the data store.

To help prevent unauthorized entities from performing such data operations on the data objects, the data store can implement role-based access control (RBAC) techniques. As those having ordinary skill in the art will appreciate, RBAC techniques can involve verifying a user's credentials (e.g., username, password) before allowing the user to perform a data operation on a data object. Unfortunately, RBAC techniques can be vulnerable to spoofing. In various cases, spoofing can involve an unauthorized entity (e.g., a malicious hacker) stealing the credentials of an authorized entity and leveraging such stolen credentials to gain access to (e.g., to delete, encrypt, and/or otherwise maliciously edit) the data objects maintained in the data store. Thus, RBAC techniques can fail to provide sufficient security to the data store, and such failure can be considered as being highly disadvantageous and/or problematic.

To help reduce the likelihood of spoofing, the data store can further implement multi-factor authentication (MFA) techniques. As those having ordinary skill in the art will appreciate, MFA techniques can involve requiring a user to input not only valid credentials but also a one-time code transmitted over email or text message to a device (e.g., email address, laptop computer, smart phone) that is known to be owned/operated by an authorized entity. However, MFA is not foolproof. For instance, if an unauthorized entity gains access to the device that is owned/operated by the authorized entity (e.g., by stealing the authorized entity's laptop and/or smart phone; by hacking into the authorized entity's email address, laptop, and/or smart phone), the unauthorized entity can nevertheless receive, and thus effectively bypass, the one-time codes that facilitate MFA. Therefore, MFA techniques, even when used in conjunction with RBAC techniques, can fail to provide sufficient security to the data store, and such failure can again be considered as being highly disadvantageous and/or problematic.

Furthermore, even in the absence of spoofing (e.g., even in the absence of credential theft), RBAC techniques and/or MFA techniques can be vulnerable to misbehavior by authorized entities. For example, it can be possible for an authorized entity to become corrupted and/or otherwise compromised over time (e.g., like a disgruntled employee). Unfortunately, such corrupted/comprised entity can utilize his/her valid credentials (e.g., which have not been stolen, but which instead have been entrusted to such entity prior to their corruption) and his/her valid one-time codes to perform unauthorized data operations on (e.g., to delete, encrypt, and/or otherwise maliciously edit) the data objects maintained in the data store. Again, this can be considered as a significant security gap, and thus a highly disadvantageous/problematic failure, of RBAC techniques and/or MFA techniques.

Accordingly, systems and/or techniques that can address one or more of these technical problems (e.g., that can ameliorate the significant security gaps of RBAC and/or MFA techniques) can thus be desirable.

Various embodiments described herein can address one or more of these technical problems. Specifically, various embodiments described herein can provide systems and/or techniques that can facilitate multi-admin verification (MAV) for improved security of data stores. In particular, various embodiments described herein can be considered as a computerized tool (e.g., any suitable combination of computer-executable hardware and/or computer-executable software) that can be electronically integrated with a data store and that can electronically maintain and/or otherwise access an MAV rule that applies to the data store. In various aspects, the MAV rule can be any suitable type of electronic data having any suitable format or dimensionality and being written in any suitable syntax. As a non-limiting example, the MAV rule can be written in Extensible Markup Language (XML). In various instances, the MAV rule can be considered as a restriction and/or regulation that governs the data store and that specifies various checks that are to be electronically verified prior to manipulating data objects stored within the data store. As described herein, such checks can be specifically configured so as to plug the security gaps left by RBAC and/or MFA techniques.

For example, suppose that the computerized tool receives an electronic request to perform a given data operation (e.g., such as a copy operation, a delete operation, a download operation, an edit operation, and/or an encrypt operation) on a given data object (e.g., such as a file, a document, an image, a video recording, an audio recording, and/or a program) that is stored within the data store. Furthermore, suppose that the electronic request was issued/created by a given credential (e.g., a given username and/or password) that has already been verified by RBAC and/or MFA techniques. As described above, notwithstanding that the given credential has already passed muster under RBAC and/or MFA techniques, there is still the possibility that the user that is utilizing the given credential and that has created the electronic request has been spoofed and/or is otherwise rogue/corrupted. In various aspects, the MAV rule can specify various checks that are configured to prevent such spoofing/corruption from harming the given data object.

In particular, the MAV rule can specify: (1) credentials (e.g., usernames and/or passwords) of entities that are authorized to issue an electronic approval with respect to the electronic request; (2) how many distinct electronic approvals are required for the electronic request to be placed into an approved state; (3) a first time limit past which the electronic request is no longer eligible for entering the approved state; (4) credentials of entities that are authorized to execute/perform the electronic request after being placed into the approved state; (5) a second time limit past which the electronic request, even if in the approved state, is not eligible for execution/performance; and/or (6) how many times the electronic request, once being in the approved state, is permitted to be executed/performed.

Accordingly, the computerized tool can perform various checks of the electronic request based on the MAV rule, such as: checking that each electronic approval that is received for the electronic request has been issued by one of the authorized approver credentials and disregarding those electronic approvals that were not issued by any of such authorized approver credentials (e.g., ensuring that each approval is by an authorized credential); checking that each electronic approval that is received for the electronic request has been issued before the first time limit elapses and disregarding those electronic approvals that were not issued within the first time limit (e.g., ensuring that each approval is timely); checking that sufficiently many non-disregarded electronic approvals have been received to place the electronic request into an approved state (e.g., ensuring that enough valid approvals have been received); checking that each electronic execution command that is received for the electronic request in the approved state has been issued by one of the authorized executor credentials and disregarding those electronic execution commands that were not issued by any of the authorized executor credentials (e.g., ensuring that each execution command is by an authorized credential); checking that each electronic execution command that is received for the electronic request in the approved state has been issued within the second time limit and disregarding those electronic execution commands that were not issued within the second time limit (e.g., ensuring that each execution command is timely); and/or checking whether the electronic request has already been executed its maximum number of times.

In various aspects, the computerized tool can perform even more checks of the electronic request based on the MAV rule, such as: checking that each electronic approval that is received for the electronic request has not been issued by the given credential and disregarding those electronic approvals that were issued by the given credential (e.g., prohibiting self-approvals); checking that each electronic execution command that is received for the electronic request has not been issued by the given credential and disregarding those electronic execution commands that were issued by the given credential (e.g., prohibiting self-executions); and/or checking that each electronic execution command that is received for the electronic request has not been issued by a same credential as any valid/accepted electronic approvals (e.g., prohibiting any one credential from both approving and executing the electronic request).

In various aspects, the electronic request can be executed when all (and/or fewer than all, in some cases) of such checks have been verified/validated. In any case, such checks can be considered as enforcing prohibitions against approvals by unauthorized entities, prohibitions against untimely approvals, prohibitions against executions by unauthorized entities, prohibitions against untimely executions, prohibitions against self-approvals, and/or prohibitions against self-executions. The enforcement of such prohibitions prior to the execution of the electronic request can help to ameliorate the harms of spoofing and/or entity corruption that are left unaddressed by RBAC and/or MFA techniques.

Indeed, as explained above, a spoofer can sidestep RBAC and/or MFA techniques by stealing the valid credentials and/or one-time codes of a single authorized entity. However, stealing the valid credentials and/or one-time codes of a single authorized entity is not sufficient to sidestep the MAV rule. Instead, to sidestep the MAV rule, the spoofer would have to steal the valid credentials and/or one-time codes of very many authorized entities (e.g., the credentials of the requesting entity, the credentials of the one or more approving entities, the credentials of the executing entity, all of which can be required to be different from each other due to the prohibition on self-approvals and/or self-executions) under time pressure (e.g., due to the time limit restrictions). Because it can be much more difficult for the spoofer to successfully steal all of such many different credentials under time pressure than it would be for the spoofer to successfully steal just one credential, the MAV rule can be considered as significantly more difficult for the spoofer to bypass as compared to RBAC and/or MFA techniques.

Such rationale also extends to situations that do not involve spoofing. Indeed, as explained above, a rogue and/or corrupted authorized entity can utilize his/her own valid credentials and/or one-time codes to satisfy RBAC and/or MFA techniques. However, his/her own valid credentials and/or one-time codes are insufficient to satisfy the MAV rule. Instead, to sidestep the MAV rule, the rogue/corrupted authorized entity would either have to become a spoofer himself/herself by successfully stealing the credentials/one-time codes of many different other authorized entities or would otherwise have to persuade such many different other authorized entities to go rogue and/or become corrupted themselves. Because it can be highly difficult for the rogue/corrupted authorized entity to successfully steal the credentials/one-time codes of such many other authorized entities and/or to successfully corrupt such many other authorized entities, the MAV rule can be considered as more difficult for the rogue/corrupted authorized entity to bypass as compared to the RBAC and/or MFA techniques.

In various embodiments, the computerized tool described herein can comprise can access component, a rule component, an approval component, and/or an execution component, and the computerized tool can be electronically integrated with a data store.

In various embodiments, the data store can be any suitable type of data storage structure as desired (e.g., object store, file system, block storage). In some cases, the data store can be centralized. In other cases, the data store can be decentralized. In various aspects, the data store can host and/or serve any suitable number of tenants (e.g., any suitable number of clients). Accordingly, in various instances, the data store can include any suitable number of tenant partitions (e.g., one or more partitions per tenant). In any case, the data store can electronically maintain a plurality of data objects for and/or on behalf of the tenants. In various aspects, a data object can be any suitable type of electronic data having any suitable format and/or dimensionality as desired (e.g., a data object can be an electronic file, an electronic document, an electronic program, a credential, or a data store setting).

In various embodiments, the access component of the computerized tool can electronically receive and/or access an electronic request that is associated with the data store. In various aspects, the access component can electronically retrieve the electronic request from any suitable computing device as desired. For example, in some instances, the access component can retrieve and/or obtain the electronic request from a computing device (e.g., a laptop computer, desktop computer, smart phone) that is owned/operated by a tenant (e.g., by a client) of the data store. In any case, the access component can electronically access the electronic request, so that other components of the computerized tool can electronically interact with (e.g., read, write, edit, manipulate) the electronic request.

In various aspects, the electronic request can be any suitable piece of electronic data that identifies a data object recorded within the data store. In various instances, the electronic request can further identify a data operation that is desired to be performed on the identified data object. Accordingly, the electronic request can be considered as a request, command, and/or instruction to perform and/or execute the identified data operation on the identified data object. In various cases, the electronic request can have been issued and/or created by a first credential (e.g., a first username and/or password). Moreover, in various aspects, the electronic request can have a first timestamp that indicates a date/time at which the first credential issued/created the electronic request.

In various aspects, as an initial attempt to ferret out unauthorized entities, the computerized tool can perform and/or otherwise facilitate any suitable RBAC technique and/or any suitable MFA technique with respect to the first credential. That is, if the first credential fails to satisfy the RBAC and/or MFA techniques, the computerized tool can disregard, discard, and/or otherwise ignore the electronic request. In fact, in some cases, if the first credential fails to satisfy the RBAC and/or MFA techniques, the computerized tool can electronically generate and/or transmit any suitable warning message as desired, where such warning message can indicate that a failed attempt has been made to perform/execute the identified data operation on the identified data object. In contrast, if the first credential satisfies the RBAC and/or MFA techniques, then the computerized tool can refrain from disregarding, discarding, and/or otherwise ignoring the electronic request.

Unfortunately, as explained above, such RBAC and/or MFA techniques can fail to sufficiently handle the technical problems of spoofing and/or entity corruption. As described herein, the computerized tool can help to ameliorate such technical problems.

In various embodiments, the rule component of the computerized tool can electronically access a multi-admin verification (MAV) rule that protects and/or otherwise safeguards the identified data object from the identified data operation. In some aspects, the rule component can electronically maintain a plurality of MAV rules, where each given MAV rule in such plurality can specify which particular data objects recorded within the data store it protects/safeguards from which particular data operations. In such case, the rule component can electronically select, identify, and/or choose from such plurality the one MAV rule that protects/safeguards the identified data object from the identified data operation.

In any case, the MAV rule can specify various checks that can help to prevent the identified data object from being exposed to the identified data operation as a result of spoofing and/or entity corruption. In particular, the MAV rule can require that the electronic request be approved by one or more other credentials before being executed. More specifically, the MAV rule can specify a threshold number of distinct and/or separate electronic approvals that are needed to place the electronic request into an approved state. As a non-limiting example, the threshold number can be k, for any suitable positive integer k. In such case, this can mean that the electronic request is not permitted to enter the approved state until k distinct/separate electronic approvals of the electronic request have been respectively issued/created by k distinct/separate credentials.

Moreover, the MAV rule can further specify a set of approver credentials (e.g., a set of usernames and/or passwords) that are known and/or deemed to be authorized to issue/create such electronic approvals. In various aspects, the set of approver credentials can include any suitable number of credentials (e.g., any suitable number of usernames and/or passwords). As a non-limiting example, the set of approver credentials can include j credentials, for any suitable positive integer j≥k. In any case, an electronic approval of the electronic request can be valid only if the electronic approval was created/issued by a credential that is within the set of approver credentials. In other words, the MAV rule can be considered as defining which specific credentials are permitted to issue/create electronic approvals for the electronic request.

Furthermore, in various aspects, the MAV rule can specify a request expiration timespan. In various instances, the request expiration timespan can denote how long (e.g., as measured in seconds, minutes, hours, days, weeks, months, years) after its creation/issuance that the electronic request is eligible to be placed in the approved state. Accordingly, an electronic approval of the electronic request can be valid only if the electronic approval was created/issued within the request expiration timespan. That is, the MAV rule can be considered as defining when an electronic approval is considered timely and/or untimely.

Further still, the MAV rule can specify that no electronic approval is permitted to be issued/created by the same credential that issued/created the electronic request. In other words, the MAV rule can prohibit self-approvals. That is, even if an electronic approval is issued/created by a credential that is within the set of approver credentials (e.g., if the credential is authorized to generate an approval), and/or even if such electronic approval is timely (e.g., is issued/generated before the request expiration timespan elapses), such electronic approval can nevertheless be deemed/considered as invalid if the credential that issued/created the electronic approval is the same (e.g., matches) that which issued/created the electronic request.

In various cases, the MAV rule can require that, after having entered the approved state, the electronic request be executed/performed only upon receipt of a valid electronic execution command. In various aspects, the MAV rule can specify a set of executor credentials (e.g., a set of usernames and/or passwords) that are known and/or deemed to be authorized to issue/create such an electronic execution command. In various instances, the set of executor credentials can include any suitable number of credentials. In any case, an electronic execution command of the electronic request can be valid only if the electronic execution command was created/issued by a credential that is within the set of executor credentials. In other words, the MAV rule can be considered as defining which specific credentials are permitted to issue/create electronic execution commands for the electronic request.

Moreover, the MAV rule can further specify an approved state expiration timespan. In various instances, the approved state expiration timespan can denote how long (e.g., as measured in seconds, minutes, hours, days, weeks, months, years) after entering the approved state that the electronic request is eligible to be executed/performed. Accordingly, an electronic execution command of the electronic request can be valid only if the electronic execution command was created/issued within the approved state expiration timespan. In other words, the MAV rule can be considered as defining when an electronic execution command is considered timely and/or untimely.

Furthermore, the MAV rule can specify that no electronic execution command is permitted to be issued/created by the same credential that issued/created the electronic request or that issued/created a valid electronic approval. In other words, the MAV rule can prohibit self-executions. That is, even if an electronic execution command is issued/created by a credential that is within the set of executor credentials (e.g., if the credential is authorized to generate an execution command), and/or even if such electronic execution command is timely (e.g., is issued/generated before the approved state expiration timespan elapses), such electronic execution command can nevertheless be deemed/considered as invalid if the credential that issued/created the electronic execution command is the same (e.g., matches) that which issued/created the electronic request or is the same (e.g., matches) that which issued/created any valid electronic approval that has been received for the electronic request.

Further still, in various aspects, the MAV rule can specify a maximum number of times that the electronic request is permitted to be executed after having entered the approved state. In various instances, the maximum number of times can have any suitable magnitude as desired. As a non-limiting example, the maximum number of times can be 1, for any suitable positive integer 1. That is, the MAV rule can be considered as defining how many times the electronic request is allowed to be executed/performed after having entered the approved state.

In various aspects, and as further described below, the approval component and/or the execution component of the computerized tool can leverage the above-described information specified by the MAV rule to help prevent a spoofer and/or a rogue/corrupted entity from performing/executing the identified data operation on the identified data object.

In various embodiments, the access component can electronically receive/access any suitable number of electronic approvals associated with the electronic request, and the approval component of the computerized tool can electronically determine which of such electronic approvals are valid. More specifically, for each given electronic approval, the approval component can discard, disregard, and/or reject the given electronic approval as invalid if: the given electronic approval was issued/created by a credential that is not within the set of approver credentials (e.g., in such case, the given electronic approval can be considered as invalid for being issued/created by an unauthorized entity); the given electronic approval was issued/created after the request expiration timespan has elapsed (e.g., in such case, the given electronic approval can be considered as invalid for being untimely); or the given electronic approval was issued/created by the same credential that issued/created the electronic request (e.g., in such case, the given electronic approval can be considered as invalid for being a self-approval, even if the credential that issued/created the given electronic approval is listed in the set of approver credentials and/or even if the given electronic approval is timely). In contrast, for each given electronic approval, the approval component can accept the given electronic approval as valid if: the given electronic approval was issued/created by a credential that is within the set of approver credentials (e.g., in such case, the approval can be considered as being issued/created by an authorized entity); the given electronic approval was issued/created before the request expiration timespan has elapsed (e.g., in such case, the given electronic approval can be considered as being timely); and the given electronic approval was issued/created by a different credential than that which issued/created the electronic request (e.g., in such case, the given electronic approval can be considered as not being a self-approval).

Furthermore, the approval component can electronically count the number of valid electronic approvals. If such number of valid electronic approvals is greater than or equal to the threshold number of distinct/separate electronic approvals that are needed to place the electronic request into the approved state, the approval component can cause the electronic request to enter the approved state. On the other hand, if such number of valid electronic approvals is less than the threshold number of distinct/separate electronic approvals that are needed to place the electronic request into the approved state, the approval component can refrain from causing the electronic request to enter the approved state.

After the electronic request enters the approved state, the access component can electronically receive/access any suitable number of electronic execution commands associated with the electronic request, and the execution component of the computerized tool can electronically determine which of such electronic execution commands are valid. More specifically, for each given electronic execution command, the execution component can discard, disregard, and/or reject the given electronic execution command as invalid if: the given electronic execution command was issued/created by a credential that is not within the set of executor credentials (e.g., in such case, the given electronic execution command can be considered as invalid for being issued/created by an unauthorized entity); the given electronic execution command was issued/created after the approved state expiration timespan has elapsed (e.g., in such case, the given electronic execution command can be considered as invalid for being untimely); or the given electronic execution command was issued/created by the same credential that issued/created the electronic request or that issued/created any valid electronic approval (e.g., in such case, the given electronic execution command can be considered as invalid for being a self-execution, even if the credential that issued/created the given electronic execution command is listed in the set of executor credentials and/or even if the given electronic execution command is timely). In contrast, for each given electronic execution command, the execution component can accept the given electronic execution command as valid if: the given electronic execution command was issued/created by a credential that is within the set of executor credentials (e.g., in such case, the given electronic execution command can be considered as being by an authorized entity); the given electronic execution command was issued/created before the approved state expiration timespan has elapsed (e.g., in such case, the given electronic execution command can be considered as being timely); and the given electronic execution command was issued/created by the different credential than that which issued/created the electronic request and those which issued/created the valid electronic approvals (e.g., in such case, the given electronic execution command can be considered as not being a self-execution).

In various aspects, for each valid electronic execution command, the execution component can execute and/or otherwise facilitate the performance of the electronic request (e.g., can apply the identified data operation to the identified data object), provided that the maximum number of times that the electronic request is permitted to be executed after having entered the approved state has not yet been reached.

To help clarify various of the above-described details, consider the following non-limiting and illustrative example. Suppose that a credential A issued/created an electronic request, where the electronic request indicates that a deletion operation is to be performed on a video file that is recorded in the data store. Furthermore, suppose that the credential A has satisfied RBAC and/or MFA techniques. Further still, suppose that an MAV rule that protects the video file from the deletion operation specifies: that two distinct electronic approvals are required to perform the deletion operation on the video file; that only the credential A, the credential B, the credential C, and the credential D are permitted to issue/create electronic approvals for the electronic request; that electronic approvals are untimely if issued/created more than one hour after the electronic request; that only the credential A, the credential C, and the credential D are permitted to issue/create electronic execution commands for the electronic request; that electronic execution commands are untimely if issued/created more than thirty minutes after the electronic request has entered the approved state; and that the electronic request can be executed only once.

Suppose that an electronic approval of the electronic request is issued/created by a credential E. Because the credential E is not listed in the set of approver credentials (e.g., is not listed in the set containing A, B, C, and D), such electronic approval can be deemed invalid as being by an unauthorized entity.

Suppose, instead, that an electronic approval of the electronic request is issued/created by the credential D two hours after the issuance/creation of the electronic request. Although the credential D is listed in the set of approver credentials (e.g., is listed in the set containing A, B, C, and D), such electronic approval is untimely (e.g., it was not issued/created within one hour of the electronic request). So, such electronic approval can be deemed invalid as being untimely.

In various cases, suppose that an electronic approval of the electronic request is issued/created by the credential A fifteen minutes after the issuance/creation of the electronic request. Although the credential A is listed in the set of approver credentials (e.g., is listed in the set containing A, B, C, and D), and although such electronic approval is timely (e.g., was issued/created within one hour of the electronic request), the credential A is the same credential that issued/created the electronic request itself. Accordingly, such electronic approval can be invalid as being a self-approval.

Now, suppose that a first electronic approval is issued/created by the credential B thirty minutes after the issuance/creation of the electronic request, and suppose that a second electronic approval is issued/created by the credential C forty-five minutes after the issuance/creation of the electronic request. In various instances, both of such electronic requests can be valid (e.g., B and C are in the set of approver credentials, both electronic approvals are timely, and neither electronic approval is a self-approval). Accordingly, upon receipt of such two electronic approvals, the electronic request can enter the approved state.

Now, suppose that an electronic execution command of the electronic request is issued/created by the credential E. Because the credential E is not listed in the set of executor credentials (e.g., is not listed in the set containing A, C, and D), such electronic execution command can be deemed invalid as being by an unauthorized entity.

Suppose, instead, that an electronic execution command of the electronic request is issued/created by the credential D one hour after the electronic request has entered the approved state. Although the credential D is listed in the set of executor credentials (e.g., is listed in the set containing A, C, and D), such electronic execution command is untimely (e.g., it was not issued/created within thirty minutes of the electronic request entering the approved state). So, such electronic execution command can be deemed invalid as being untimely.

In various cases, suppose that an electronic execution command of the electronic request is issued/created by the credential A fifteen minutes after the electronic request is placed in the approved state. Although the credential A is listed in the set of executor credentials (e.g., is listed in the set containing A, C, and D), and although such electronic execution command is timely (e.g., was issued/created within thirty minutes of the electronic request being in the approved state), the credential A is the same credential that issued/created the electronic request itself. Accordingly, such electronic execution command can be invalid as being a self-execution.

In various aspects, suppose that an electronic execution command of the electronic request is issued/created by the credential C twenty minutes after the electronic request is placed in the approved state. Although the credential C is listed in the set of executor credentials (e.g., is listed in the set containing A, C, and D), and although such electronic execution command is timely (e.g., was issued/created within thirty minutes of the electronic request being in the approved state), the credential C is the same credential that actually issued/created a valid electronic approval for the electronic request. Accordingly, such electronic execution command can be invalid as being an alternative type of self-execution.

Finally, suppose that an electronic execution command of the electronic request is issued/created by the credential D twenty-five minutes after the electronic request enters the approved state. Such electronic execution command can be valid (e.g., D is in the set of executor credentials; the electronic execution command is timely; D did not issue/create the electronic request; D did not issue/create a valid electronic approval for the electronic request, even though D had the authority to do so since D was in the set of approver credentials). Accordingly, the electronic request can be executed/performed (e.g., the deletion command can be performed on the video file), provided that the electronic request has not already been executed (e.g., as mentioned above in this example, the maximum number of permissible executions can be one).

As shown by this non-limiting and illustrative example, the deletion request can be performed on the video file only after the credential A issued/created the electronic request, the credential B and the credential C respectively issued/created two valid electronic approvals, and the credential D issued/created a valid electronic execution command. In other words, the MAV rule required all of the credentials A, B, C, and D to operate in concert to apply the deletion command to the video file. Accordingly, if a spoofer wanted to perform the deletion operation on the video file, the spoofer would have to successfully steal not just the credential A, but also the credentials B, C, and D under time pressure. Or, if any one of the credentials A, B, C, and D became rogue/corrupted, that credential would have to steal and/or corrupt the remaining three credentials in order to apply the deletion operation to the video file. In any case, this can be considered as a highly difficult task. In contrast, without the MAV rule, a spoofer would be able to perform the deletion operation on the video file by successfully stealing any one of the credentials A, B, C, and/or D. Likewise, without the MAV rule, any one of the credentials A, B, C, and/or D going rogue/corrupted would be sufficient to perform the deletion operation on the video file. Therefore, the MAV rule can be considered as helping to plug the significant security gaps left by RBAC and/or MFA techniques.

Various embodiments described herein can be employed to use hardware and/or software to solve problems that are highly technical in nature (e.g., to facilitate multi-admin verification for improved security of data stores), that are not abstract and that cannot be performed as a set of mental acts by a human. Further, some of the processes performed can be performed by a specialized computer (e.g., data store, credential analyzer). In various aspects, some defined tasks associated with various embodiments described herein can include: accessing, by a device operatively coupled to a processor, an electronic request associated with a data store, wherein the electronic request can indicate a data operation that is to be applied to a data object recorded in the data store; accessing, by the device, a multi-admin verification rule that protects the data object from the data operation, wherein the multi-admin verification rule can specify how many distinct electronic approvals are needed to place the electronic request into an approved state, wherein the multi-admin verification rule can further specify a list of credentials that are authorized to generate such electronic approvals, wherein the multi-admin verification rule can further specify a time limit past which the electronic request is no longer eligible to enter the approved state, wherein the multi-admin verification rule can further specify a list of credentials that are authorized to generate electronic execution commands for the electronic request after the electronic request is in the approved state, wherein the multi-admin verification rule can further specify a time limit past which the electronic request is no longer eligible to be executed/performed, wherein the multi-admin verification rule can further specify how many times the electronic request is permitted to be executed/performed after entering the approved state, and/or wherein the multi-admin verification rule can further prohibit self-approvals and/or self-executions; and/or validating, by the device, one or more electronic approvals and/or electronic execution commands that are associated with the electronic request in accordance with the MAV rule.

Neither the human mind nor a human with pen and paper can electronically access such an electronic request, can electronically access such an MAV rule, and/or can electronically validate/verify whether electronic approvals and/or electronic execution commands corresponding to the electronic request satisfy the MAV rule. Indeed, a data store (e.g., a cloud storage platform, such as S3) is a specific combination of computer-executable hardware and computer-executable software that cannot be implemented in any way without computers. Accordingly, a computerized tool that can electronically implement an MAV rule that specifies various specific security checks pertaining to security credentials (e.g., usernames, passwords), which help to defend a data store against spoofing and/or corrupted/rogue entities, is likewise a specific combination of computer-executable hardware and/or computer-executable software that cannot be implemented in any sensible, practical, and/or reasonable way outside of a computing environment.

In various instances, one or more embodiments described herein can be integrated into a practical application. Indeed, as mentioned above, a data store can rely upon RBAC and/or MFA techniques for security. However, as explained above, such RBAC and/or MFA techniques can be vulnerable to spoofing and/or to authorized entities that go rogue. That is, RBAC and/or MFA techniques can leave significant security gaps that threaten the integrity of the data store. To address this technical problem, the present inventors have devised various embodiments described herein, which can be considered as a computerized tool that can implement multi-admin verification (MAV). More specifically, whenever a data operation is requested to be performed on a data object that is recorded within a data store, the computerized tool can perform various security checks according to an MAV rule that protects the data object from the data operation, where such security checks can be considered as plugging the gaps left by RBAC and/or MFA techniques. In particular, the MAV rule can specify: how many separate electronic approvals are required to perform the data operation on the data object; which credentials are authorized to provide such electronic approvals; how much time is allotted for those electronic approvals to be provided; which credentials are authorized to execute/perform the data operation on the data object once approved; how much time is allotted for such execution/performance to be conducted; and/or how many times the data operation is permitted to be performed on the data object. Furthermore, the MAV rule can prohibit self-approvals and/or self-executions. Accordingly, the computerized tool can prevent the data operation from being performed/executed on the data object until the MAV rule is satisfied, and the configuration/make-up of the MAV rule can, as described, be such that it is exceedingly difficult for a spoofer and/or a rogue entity to satisfy the MAV rule. In stark contrast, if the data object were instead protected from the data operation only by RBAC and/or MFA techniques and not by the MAV rule, a spoofer and/or rogue entity would be easily able to perform/execute the data operation on the data object. A computerized tool that can provide a higher level of security for a data store as compared to RBAC and/or MFA techniques certainly constitutes a tangible and concrete technical improvement in the field of data stores, and thus surely qualifies as a practical application of computers.

Furthermore, various embodiments described herein can control real-world, tangible devices based on the disclosed teachings. For example, in various aspects, various embodiments described herein can electronically access and/or query a real-world data store (e.g., a real-world cloud object store, like S3) and can electronically perform real-world security checks on real-world requests for operations to be performed/executed on objects stored in such a real-world data store.

It should be appreciated that the figures and the herein disclosure describe non-limiting examples of various embodiments described herein, and it should further be appreciated that the figures are not necessarily drawn to scale.

### Example Architecture for Multi-Admin Verification

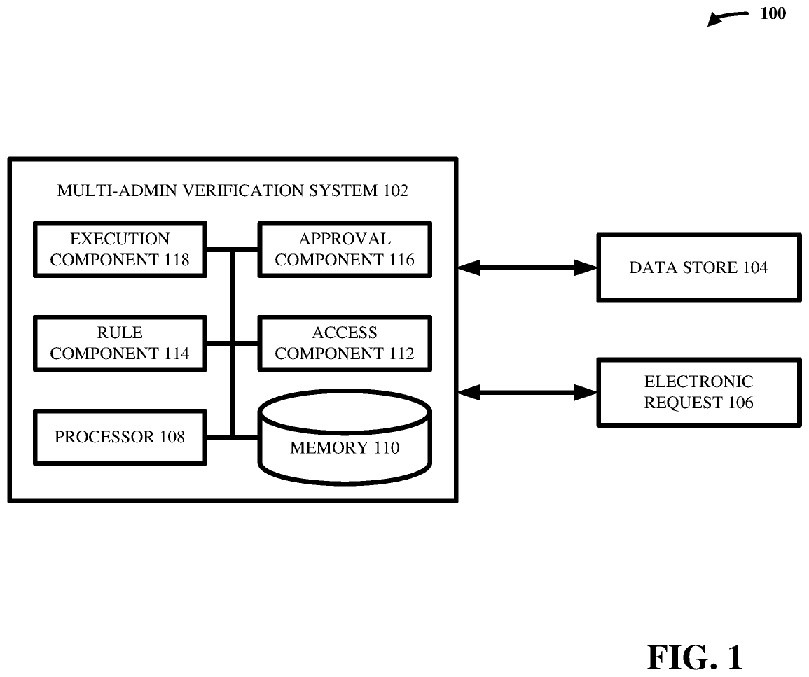

FIG. 1 illustrates a block diagram of an example, non-limiting system 100 that can facilitate multi-admin verification for improved security of data stores in accordance with one or more embodiments described herein. As shown, a multi-admin verification system 102 (hereafter “MAV system 102”) can be electronically integrated, via any suitable wired and/or wireless electronic connections, with a data store 104 and/or with an electronic request 106.

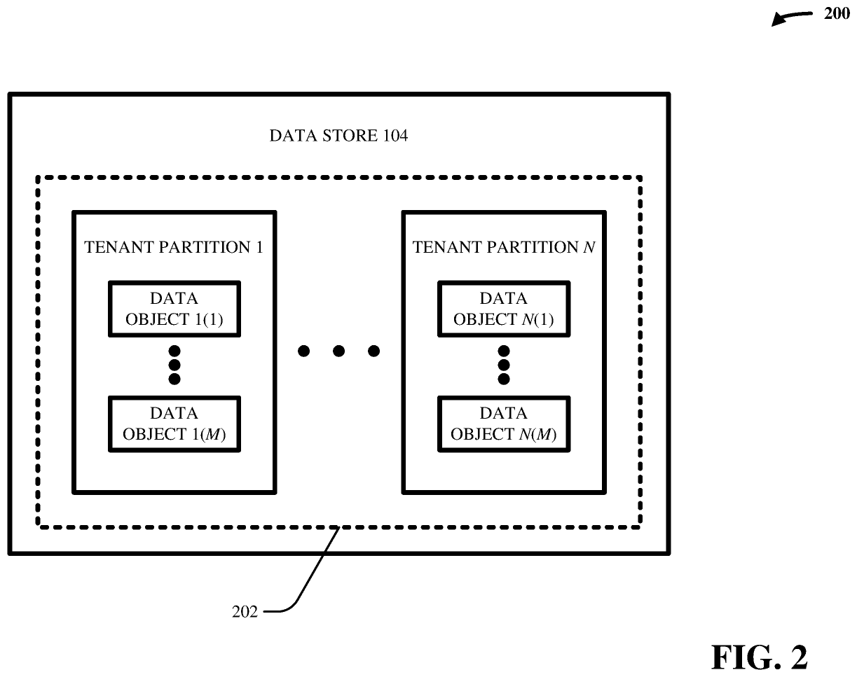

In various embodiments, the data store 104 can be any suitable type of electronic and/or computerized data store as desired, whether centralized and/or distributed, and/or whether relational and/or graph-based. As a non-limiting example, the data store 104 can be a cloud data store. As another non-limiting example, the data store 104 can be an object store. As yet another non-limiting example, the data store 104 can be a file system. As still another non-limiting example, the data store 104 can be a block store. As even another non-limiting example, the data store 104 can be hierarchical. In any case, the data store 104 can electronically store, electronically record, and/or otherwise electronically maintain any suitable number of data objects for and/or on behalf of any suitable number of tenants/clients. This is further described with respect to FIG. 2.

FIG. 2 illustrates an example, non-limiting block diagram 200 of a data store in accordance with one or more embodiments described herein. That is, FIG. 2 depicts an example, non-limiting embodiment of the data store 104.

As shown, the data store 104 can include a set of tenant partitions 202. In various aspects, the set of tenant partitions 202 can include n partitions for any suitable positive integer n: a tenant partition 1 to a tenant partition n. In various instances, a tenant partition can be any suitable portion and/or shard of the data store 104 that can be dedicated to serving a respectively corresponding tenant and/or client. For example, the tenant partition 1 can correspond to a first tenant/client, which can mean that the tenant partition 1 can be considered as serving, hosting, and/or otherwise storing data for and/or on behalf of the first tenant/client. As another example, the tenant partition n can correspond to an n-th tenant/client, which can mean that the tenant partition n can be considered as serving, hosting, and/or otherwise storing data for and/or on behalf of the n-th tenant/client. Accordingly, when n>1, the data store 104 can be considered as a multi-tenancy data storage platform. In contrast, when n=1, the data store 104 can be considered as a mono-tenancy data storage platform.

In any case, each of the set of tenant partitions 202 can electronically store, record, and/or maintain data objects for its respectively corresponding tenant/client. As a non-limiting example, the tenant partition 1 can store, record, and/or maintain m data objects for the first tenant/client, for any suitable positive integer m: a data object 1(1) to a data object 1(m). Stated differently, the first tenant/client can electronically transmit the data object 1(1) to the data object 1(m) to the tenant partition 1 for purposes of electronic storage. As another non-limiting example, the tenant partition n can store, record, and/or maintain m data objects for the n-th tenant/client, for any suitable positive integer m: a data object n(1) to a data object n(m). As above, this can mean that the n-th tenant/client can electronically transmit the data object n(1) to the data object n(m) to the tenant partition n for purposes of electronic storage.

In any case, a data object can be any suitable piece of electronic data having any suitable properties, attributes, and/or characteristics as desired. For instance, a data object can exhibit any suitable format and/or dimensionality (e.g., can be one or more scalars, vectors, matrices, tensors, and/or character strings), can exhibit any suitable size and/or memory consumption (e.g., as measured in bytes), can exhibit any suitable type (e.g., can be a textual file/document, can be an image, can be a video recording, can be an audio recording, can be timeseries data, can be waveform data, can be executable programs or portions of programs, and/or can be an executable script defining a program/application), can exhibit any suitable time of creation and/or time of editing (e.g., created on Jan. 20, 2017; last edited on Dec. 4, 2019), can exhibit any suitable level of security clearance (e.g., high security clearance, intermediate security clearance, low security clearance), and/or can exhibit any other suitable metadata attribute/property/characteristic as desired. Those having ordinary skill in the art will appreciate that different data objects in the data store 104 can have the same and/or different properties, attributes, and/or characteristics as each other (e.g., the same and/or different formats/dimensionalities, the same and/or different sizes, the same and/or different types, the same and/or different dates of creation/editing, the same and/or different security clearance levels).

Although not explicitly shown in FIG. 2, any suitable data operations can be performed on any of the data objects that are stored, recorded, and/or maintained in the data store 104. As a non-limiting example, one of such data operations can be a delete operation, which can delete and/or remove a data object from the data store 104. As another non-limiting example, one of such data operations can be an edit operation, which can edit some aspect of a data object that is within the data store 104. As yet another non-limiting example, one of such data operations can be a copy operation, which can duplicate a data object that is within the data store 104. As still another non-limiting example, one of such data operations can be a download operation, which can transmit a copy of a data object within the data store 104 to a local hard drive. As even another non-limiting example, one of such data operations can be an encrypt operation, which can convert a data object within the data store 104 into cypher code. Those having ordinary skill in the art will appreciate that any other suitable data operations that can somehow manipulate one or more data objects can be facilitated and/or implementable by the data store 104.

Although FIG. 2 illustrates each of the set of tenant partitions 202 as having the same number of data objects as each other (e.g., each having m data objects), this is a mere non-limiting example for ease of illustration. Those having ordinary skill in the art will appreciate that different tenant partitions can have the same and/or different numbers and/or types of data objects as each other.

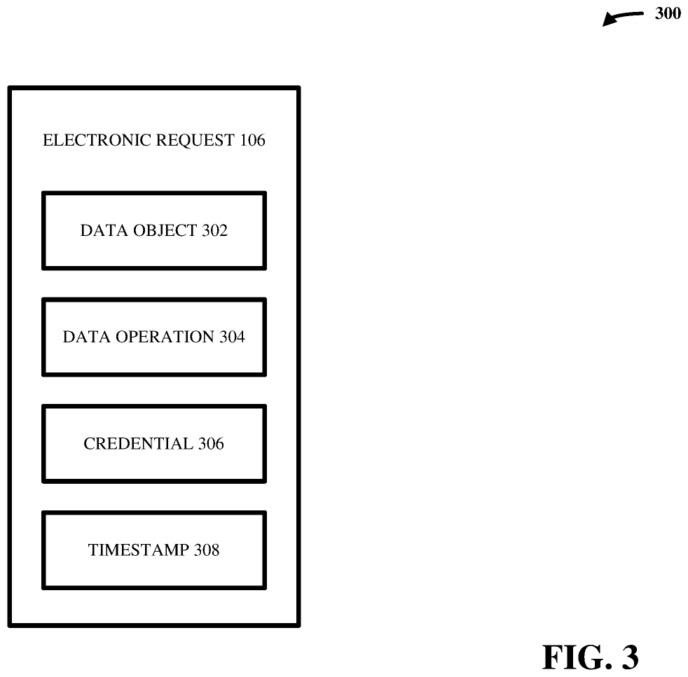

In various embodiments, the electronic request 106 can correspond to the data store 104. In particular, the electronic request 106 can specify a data operation that is desired to be performed on a data object that is stored within the data store 104. This is further explained with respect to FIG. 3.

FIG. 3 illustrates an example, non-limiting block diagram 300 of an electronic request associated with a data store in accordance with one or more embodiments described herein. In other words, FIG. 3 depicts a non-limiting, example embodiment of the electronic request 106.

In various embodiments, as shown, the electronic request 106 can be any suitable type of electronic data that specifies, identifies, and/or otherwise indicates a data object 302, a data operation 304, a credential 306, and/or a timestamp 308. In various aspects, the data object 302 can be any one of the data objects that are stored, recorded, and/or otherwise maintained in the data store 104. In various instances, the data operation 304 can be any one of the data operations that can be facilitated and/or implemented on the data object 302 by the data store 104. In various cases, the credential 306 can be any suitable username, password, and/or electronic profile that issued, created, and/or otherwise generated the electronic request 106. In various aspects, the timestamp 308 can be any suitable piece of electronic data that indicates when (e.g., a time and/or date) the electronic request 106 was issued, created, and/or otherwise generated by the credential 306. Accordingly, in various instances, the electronic request 106 can be considered and/or interpreted as an indication that the credential 306 requested, at a time/date indicated by the timestamp 308, that the data operation 304 be performed/executed on the data object 302.

Although FIG. 3 depicts the data object 302 and/or the data operation 304 as being singular, this is a mere non-limiting example for ease of illustration and/or explanation. Those having ordinary skill in the art will appreciate that, in various embodiments, any suitable number of data objects and/or any suitable number of data operations can be indicated/identified in the electronic request 106 (e.g., can be identified by unique object identifiers and/or by any other suitable property, attribute, and/or characteristic as desired).

Referring back to FIG. 1, to help defend the data store 104 from unauthorized entities, the MAV system 102 can perform and/or facilitate any suitable RBAC techniques and/or any suitable MFA techniques on the electronic request 106. That is, the MAV system 102 can determine whether or not the credential 306 is a valid credential. If the credential 306 is not a valid credential (e.g., if the credential 306 fails to satisfy the RBAC and/or MFA techniques), then the MAV system 102 can ignore, discard, and/or disregard the electronic request 106. However, if the credential 306 is a valid credential (e.g., if the credential 306 satisfies the RBAC and/or MFA techniques), it can nevertheless be possible that the credential 306 is being utilized by a spoofer and/or a recently corrupted/rogue entity that desires to maliciously manipulate the data object 302. In other words, RBAC and/or MFA techniques are not sufficient to defend the data store 104 and/or the data object 302 from spoofers and/or rogue/corrupted entities. Fortunately, the MAV system 102 can help to solve this technical problem, as described herein.

In various embodiments, the MAV system 102 can comprise a processor 108 (e.g., computer processing unit, microprocessor) and a computer-readable memory 110 that is operably connected/coupled to the processor 108. The memory 110 can store computer-executable instructions which, upon execution by the processor 108, can cause the processor 108 and/or other components of the MAV system 102 (e.g., access component 112, rule component 114, approval component 116, execution component 118) to perform one or more acts. In various embodiments, the memory 110 can store computer-executable components (e.g., access component 112, rule component 114, approval component 116, execution component 118), and the processor 108 can execute the computer-executable components.

In various embodiments, the MAV system 102 can comprise an access component 112. In various aspects, the access component 112 can electronically receive, retrieve, obtain, and/or otherwise access the electronic request 106 and/or the data store 104. In some cases, the access component 112 can electronically retrieve the electronic request 106 and/or the data store 104 from any suitable computing devices (not shown) as desired. In any case, the access component 112 can electronically access the electronic request 106 and/or the data store 104, such that other components of the MAV system 102 can electronically interact with the electronic request 106 and/or the data store 104.

In various embodiments, the MAV system 102 can further comprise a rule component 114. In various aspects, as described herein, the rule component 114 can electronically access a multi-admin verification (MAV) rule, based on the electronic request 106. In various cases, the MAV rule can be considered as a restriction and/or regulation that specifies various particular protections that help to safeguard the data object 302 from the data operation 304.

In various embodiments, the MAV system 102 can further comprise an approval component 116 and/or an execution component 118. In various instances, as described herein, the approval component 116 and/or the execution component 118 can electronically ensure that the electronic request 106 remains unexecuted/unperformed until the electronic request 106 satisfies the MAV rule.

Because, as explained further herein, it can be more difficult for a spoofer and/or rogue/corrupted entity to satisfy the MAV rule than it can be for the spoofer and/or rogue/corrupted entity to satisfy RBAC and/or MFA techniques, the MAV system 102 can be considered as protecting the data object 302 from security threats that RBAC and/or MFA techniques cannot thwart (e.g., the MAV system 102 can be considered as filling the security gaps that are left by RBAC and/or MFA techniques).

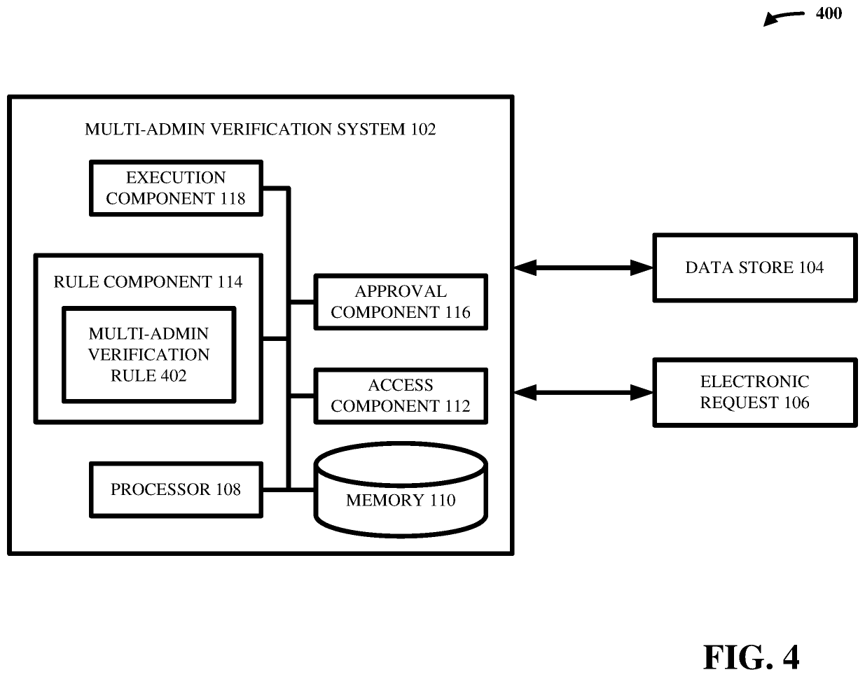

FIG. 4 illustrates a block diagram of an example, non-limiting system 400 including a multi-admin verification rule that can facilitate multi-admin verification for improved security of data stores in accordance with one or more embodiments described herein. As shown, the system 400 can, in some cases, comprise the same components as the system 100, and can further comprise a multi-admin verification rule 402 (hereafter “MAV rule 402”).

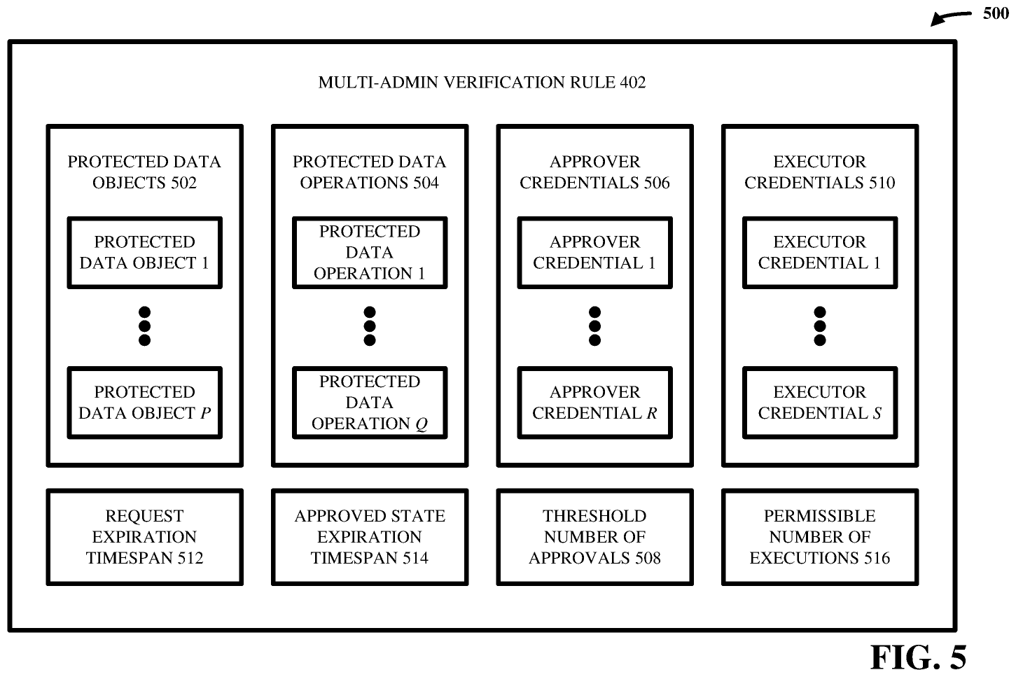

In various embodiments, the rule component 114 can electronically store, electronically maintain, and/or otherwise electronically access the MAV rule 402. In various aspects, the MAV rule 402 can be considered as an electronic restriction and/or electronic regulation that can help to protect the data object 302 from spoofers and/or rogue entities that desire to maliciously apply the data operation 304 to the data object 302. This is further described with respect to FIG. 5.

FIG. 5 illustrates an example, non-limiting block diagram 500 of a multi-admin verification rule in accordance with one or more embodiments described herein. That is, FIG. 5 depicts a non-limiting, example embodiment of the MAV rule 402.

In various embodiments, as shown, the MAV rule 402 can specify and/or otherwise indicate a set of protected data objects 502. In various aspects, the set of protected data objects 502 can be a list of any suitable number of data objects that are stored within the data store 104. In various instances, the set of protected data objects 502 can be considered as representing and/or identifying those data objects in the data store 104 that are safeguarded and/or otherwise defended from spoofers and/or rogue entities by the MAV rule 402. As a non-limiting example, the set of protected data objects 502 can include p data objects, for any suitable positive integer p: a protected data object 1 to a protected data object p.

In various aspects, as shown, the MAV rule 402 can further specify and/or otherwise indicate a set of protected data operations 504. In various instances, the set of protected data operations 504 can be a list of any suitable number of data operations that can be performed and/or implemented on any of the set of protected data objects 502 via the data store 104. As a non-limiting example, the set of protected data operations 504 can include q data operations, for any suitable positive integer q: a protected data operation 1 to a protected data operation q. In various cases, the MAV rule 402 can be considered as taking effect whenever any of the set of protected data operations 504 is requested to be performed/executed on any of the set of protected data objects 502. In other words, when at least one of the set of protected data operations 504 is requested to be performed/executed on at least one of the set of protected data objects 502, such request can be prohibited from being executed/performed, unless such request complies with the below-described requirements of the MAV rule 402 (e.g., so as to help prevent a spoofer and/or a rogue entity from maliciously performing/executing any of the set of protected data operations 504 on any of the set of protected data objects 502).

Although not explicitly shown in FIG. 5, the MAV rule 402 can be considered as prohibiting a request to perform any of the set of protected data operations 504 on any of the set of protected data objects 502, until such request has entered an approved state. In various cases, the MAV rule 402 can be considered as specifying the requirements for such a request to enter the approved state. Such requirements are described below.

In various instances, as shown, the MAV rule 402 can specify and/or otherwise indicate a threshold number of approvals 508. In various instances, the threshold number of approvals 508 can be any suitable positive integer that denotes how many distinct/separate valid electronic approvals are needed to allow a request to perform any of the set of protected data operations 504 on any of the set of protected data objects 502 to enter the approved state. In some cases, the threshold number of approvals 508 can be equal to one, indicating that only one valid electronic approval is needed for such a request to enter the approved state. In other cases, the threshold number of approvals 508 can be greater than 1, indicating that more than one valid electronic approval is need for such a request to enter the approved state.

In various aspects, as shown, the MAV rule 402 can further specify and/or otherwise indicate a set of approver credentials 506. In various cases, the set of approver credentials 506 can include any suitable number of credentials. For example, the set of approver credentials 506 can include r credentials, for any suitable positive integer r: an approver credential 1 to an approver credential r. In various aspects, each approver credential can be any suitable username, password, and/or electronic profile that is known, deemed, and/or otherwise authorized to issue an electronic approval of a request to perform any of the set of protected data operations 504 on any of the set of protected data objects 502. In other words, an electronic approval for a request to perform any of the set of protected data operations 504 on any of the set of protected data objects 502 can be invalid, unless such electronic approval was issued by one of the set of approver credentials 506. In various cases, the MAV rule 402 can prohibit any of the set of approver credentials 506 from submitting more than one valid electronic approval for any given request. In such case, the threshold number of approvals 508 can be less than and/or equal to r (e.g., one valid request per approver credential).

Furthermore, as shown, the MAV rule 402 can specify and/or otherwise indicate a request expiration timespan 512. In various aspects, the request expiration timespan 512 can be any suitable length of time (e.g., as measured in seconds, minutes, hours, days, weeks, years, decades) during which a request to perform any of the set of protected data operations 504 on any of the set of protected data objects 502 is eligible for entering the approved state and/or after which such request is no longer eligible for entering the approved state (e.g., the request expiration timespan 512 can be measured from the time/date on which such a request was issued). That is, an electronic approval for a request to perform any of the set of protected data operations 504 on any of the set of protected data objects 502 can be invalid, unless such electronic approval is issued before the request expiration timespan 512 elapses.

Although not explicitly shown in FIG. 5, the MAV rule 402 can further prohibit self-approvals. In other words, an electronic approval of a request to perform any of the set of protected data operations 504 on any of the set of protected data objects 502 can be valid only if such electronic approval is issued by a credential that is not the same as (e.g., that does not match) that which issued such request. Conversely, an electronic approval of such a request is invalid if such electronic approval is issued by the same credential that issued such request, notwithstanding that such credential might be listed in the set of approver credentials 506.

Accordingly, an electronic approval of a request to perform any of the set of protected data operations 504 on any of the set of protected data objects 502 can be valid only if such electronic approval: is issued by one of the set of approver credentials 506; is issued within the request expiration timespan 512; and is not issued by the same credential that issued the request.

When the total number of valid electronic approvals for a request to perform any of the set of protected data operations 504 on any of the set of protected data objects 502 meets and/or exceeds the threshold number of approvals 508, such request can enter the approved state.

Although not explicitly shown in FIG. 5, even after a request to perform any of the set of protected data operations 504 on any of the set of protected data objects 502 has entered the approved state, the MAV rule 402 can be considered as prohibiting the execution/performance of such request, until a valid electronic execution command is received. In various cases, the MAV rule 402 can be considered as specifying the requirements for such a valid electronic execution command. Such requirements are described below.

In various aspects, as shown, the MAV rule 402 can specify and/or otherwise indicate a set of executor credentials 510. In various instances, the set of executor credentials 510 can include any suitable number of credentials. For example, the set of executor credentials 510 can include s credentials, for any suitable positive integer s: an executor credential 1 to an executor credential s. In various cases, each executor credential can be any suitable username, password, and/or electronic profile that is known, deemed, and/or otherwise authorized to issue an electronic execution command of a request to perform any of the set of protected data operations 504 on any of the set of protected data objects 502. In other words, an electronic execution command for a request to perform any of the set of protected data operations 504 on any of the set of protected data objects 502 can be invalid, unless such electronic execution command was issued by one of the set of executor credentials 510.

Furthermore, as shown, the MAV rule 402 can specify and/or otherwise indicate an approved state expiration timespan 514. In various aspects, the approved state expiration timespan 514 can be any suitable length of time (e.g., as measured in seconds, minutes, hours, days, weeks, years, decades) during which a request to perform any of the set of protected data operations 504 on any of the set of protected data objects 502 that has entered the approved state is eligible for being executed/performed and/or after which such request is no longer eligible for being executed/performed (e.g., the approved state expiration timespan 514 can be measured from the time/date on which such a request entered the approved state). That is, an electronic execution command for a request to perform any of the set of protected data operations 504 on any of the set of protected data objects 502 can be invalid, unless such electronic execution command is issued before the approved state expiration timespan 514 elapses.

Although not explicitly shown in FIG. 5, the MAV rule 402 can further prohibit self-executions. In other words, an electronic execution command of a request to perform any of the set of protected data operations 504 on any of the set of protected data objects 502 can be valid only if such electronic execution command is issued by a credential that is not the same as (e.g., that does not match) that which issued such request and/or that which issued any valid electronic approval for such request. Conversely, an electronic execution command of such a request is invalid if such electronic execution command is issued by the same credential that issued such request and/or by the same credential that issued any valid electronic approval for such request, notwithstanding that such credential might be listed in the set of executor credentials 510.

Further still, as shown in FIG. 5, the MAV rule 402 can specify and/or indicate a permissible number of executions 516. In various aspects, the permissible number of executions 516 can be any suitable positive integer that denotes how many distinct/separate times that a request to perform any of the set of protected data operations 504 on any of the set of protected data objects 502 is allowed to be performed/executed after having entered the approved state. In some cases, the permissible number of executions 516 can be equal to one, indicating that such a request can be executed/performed only one time after entering the approved state. In other cases, the permissible number of executions 516 can be greater than 1, indicating that such a request can be executed/performed more than one time after entering the approved state.

Accordingly, an electronic execution command for a request to perform any of the set of protected data operations 504 on any of the set of protected data objects 502 can be valid only if: such request has entered the approved state; such electronic execution command is issued by one of the set of executor credentials 510; such electronic execution command is issued within the approved state expiration timespan 514; and such electronic execution command is not issued by the same credential that issued the request or that issued any valid electronic approval of such request. Moreover, even if a valid electronic execution command is received for a request to perform any of the set of protected data operations 504 on any of the set of protected data objects 502, the MAV rule 402 can nevertheless prohibit such request from being executed/performed if the permissible number of executions 516 has already been reached/attained.

For purposes of illustration and explanation, a non-limiting example of the MAV rule 402 written in XML syntax is presented below.

| Line 1 <?xml version=“1.0”?> | |
|---|---|
| Line 2 <MAV rule> | |
| Line 3 | <title> Example Multi-Admin Verification Rule </title> |
| Line 4 | <data objects> |
| Line 5 | <file>filename.docx</file> |
| Line 6 | <object store>s3.example_target.myquobyte.net</object store> |
| Line 7 | <NoSQL>https://www.patentex.com/testdb/20493/></NoSQL> |
| Line 8 | </data objects> |
| Line 9 | <operations> |
| Line 10 | <operation>write</operation> |
| Line 11 | <operation>erase</operation> |
| Line 12 | </operations> |
| Line 13 | <approver> |
| Line 14 | <user>Admin 1</user> |
| Line 15 | <user>Admin 2</user> |
| Line 16 | <user>Admin 3</user> |
| Line 17 | </approver> |
| Line 18 | <executor> |
| Line 19 | <user>Admin 1</user> |
| Line 20 | <user>Admin 4</user> |
| Line 21 | </executor> |
| Line 22 | <request expiration time>15</request expiration time> |
| Line 23 | <approved expiration time>10</approved expiration time> |
| Line 24 | <approval threshold>2</approval threshold> |
| Line 25 | <number executions>3</number executions> |
| Line 26 | <self-approval>no</self-approval> |
| Line 27 | <self-execution>no</self-execution> |

Line 28 </MAV rule>

In such non-limiting example, Line 1 can be considered as denoting or specifying an XML syntax version in which the non-limiting example of the MAV rule 402 is written, and Lines 2-28 can be considered as denoting or specifying the contents of the non-limiting example of the MAV rule 402. In various aspects, Line 3 can be considered as denoting or specifying a title of the non-limiting example of the MAV rule 402. In this particular illustration, the non-limiting example of the MAV rule 402 can be entitled “Example Multi-Admin Verification Rule”.

In various instances, Lines 4-8 can be considered as denoting or specifying the particular data objects that are protected by the Example Multi-Admin Verification Rule. In other words, Lines 4-8 can be considered as indicating the set of protected data objects 502. As shown in this particular illustration, the Example Multi-Admin Verification Rule can protect a specific file (e.g., denoted by Line 5), a specific object store (e.g., denoted by Line 6), and a specific NoSQL database (e.g., denoted by Line 7).

In various cases, Lines 9-12 can be considered as denoting or specifying the particular data operations that are governed by the Example Multi-Admin Verification Rule. In other words, Lines 9-12 can be considered as indicating the set of protected data operations 504. As shown in this particular illustration, the Example Multi-Admin Verification Rule can govern or otherwise apply to a write operation (e.g., denoted by Line 10) and an erase operation (e.g., denoted by Line 11).

In various cases, Lines 13-17 can be considered as denoting or specifying the credentials or identifiers of the particular entities that are allowed to approve a request to perform any of the set of protected data operations 504 on any of the set of protected data objects 502. In other words, Lines 13-17 can be considered as indicating the set of approver credentials 506. As shown in this particular illustration, the Example Multi-Admin Verification Rule can specify that an Admin 1 (e.g., denoted by Line 14), an Admin 2 (e.g., denoted by Line 15), and an Admin 3 (e.g., Line 16) are permitted to provide valid electronic approvals.

In various aspects, Lines 18-21 can be considered as denoting or specifying the credentials or identifiers of the particular entities that are allowed to execute an approved request to perform any of the set of protected data operations 504 on any of the set of protected data objects 502. In other words, Lines 18-21 can be considered as indicating the set of executor credentials 510. As shown in this particular illustration, the Example Multi-Admin Verification Rule can specify that the Admin 1 (e.g., denoted by Line 19) and an Admin 4 (e.g., denoted by Line 20) are permitted to provide valid electronic execution commands.

In various instances, Line 22 can be considered as denoting or otherwise specifying an amount of time during which a request to perform any of the set of protected data operations 504 on any of the set of protected data objects 502 can be approved by the set of approver credentials 506. In other words, Line 22 can be considered as indicating the request expiration timespan 512. As shown in this non-limiting illustration, the request expiration timespan 512 can be 15 units following generation of the request (e.g., 15 minutes after generation of the request, 15 hours after generation of the request, 15 days after generation of the request).

In various cases, Line 23 can be considered as denoting or otherwise specifying an amount of time during which an approved request to perform any of the set of protected data operations 504 on any of the set of protected data objects 502 can be executed by the set of executor credentials 510. In other words, Line 23 can be considered as indicating the approved state expiration timespan 514. As shown in this non-limiting illustration, the approved state expiration timespan 514 can be 10 units after approval of the request (e.g., 10 minutes after approval of the request, 10 hours after approval of the request, 10 days after approval of the request).

In various aspects, Line 24 can be considered as denoting or otherwise specifying how many valid electronic approvals are needed to approve a request to perform any of the set of protected data operations 504 on any of the set of protected data objects 502. That is, Line 24 can be considered as indicating the threshold number of approvals 508. As shown in this non-limiting illustration, the threshold number of approvals 508 can be 2. That is, two of the set of approver credentials 506 (e.g., any two of the Admin 1, the Admin 2, or the Admin 3) can be required to place the request into an approved state. Although not explicitly shown, Line 24 can be implemented with any suitable counters or trackers that can be incremented as valid electronic approvals are received.

In various instances, Line 25 can be considered as denoting or otherwise specifying how many times a request to perform any of the set of protected data operations 504 on any of the set of protected data objects 502 can be executed upon entering the approved state. That is, Line 25 can be considered as indicating the permissible number of executions 516. As shown in this non-limiting illustration, the permissible number of executions 516 can be 3. That is, after the request is placed in the approved state, such request can be executed three times by the set of executor credentials 510 (e.g., by the Admin 1 or the Admin 4).

In various cases, Line 26 can be considered as denoting or otherwise specifying that self-approvals are impermissible. In other words, Line 26 can be considered as prohibiting an entity from providing an electronic approval for a request to perform any of the set of protected data operations 504 on any of the set of protected data objects 502, if such entity generated such request. This is notwithstanding that such entity might nevertheless be listed within the set of approver credentials 506. For example, suppose that Admin 2 generates a request to write or erase the file specified in Line 5. In such case, any electronic approval from Admin 2 of such request can be treated as invalid per Line 26, notwithstanding that Admin 2 is listed in Line 15 as an approver entity.

In various aspects, Line 27 can be considered as denoting or otherwise specifying that self-executions are impermissible. That is, Line 27 can be considered as prohibiting an entity from providing an electronic execution command for an approved request to perform any of the set of protected data operations 504 on any of the set of protected data objects 502, if such entity generated such request or provided a valid approval for such request. This is notwithstanding that such entity might nevertheless be listed within the set of executor credentials 510. For example, suppose that Admin 1 generates a request to write or erase an element of the object store specified in Line 6, and suppose that such request is placed into the approved state. In such case, any electronic execution command from Admin 1 for such approved request can be treated as invalid per Line 27, notwithstanding that Admin 1 is listed in Line 19 as an executor entity. As another example, suppose that Admin 3 generates a request to write or erase an element of the NoSQL database specified in Line 7, suppose that such request is placed into the approved state, and further suppose that Admin 1 provides a valid electronic approval of such request. In such case, any electronic execution command from Admin 1 for such approved request can be treated as invalid per Line 27, notwithstanding that Admin 1 is listed in Line 19 as an executor entity.

Thus, as mentioned above, the MAV rule 402 can be considered providing a line of defense against spoofers and/or rogue entities that desire to maliciously execute any of set of protected data operations 504 on any of the set of protected data objects 502. In various aspects, the data object 302 can be within the set of protected data objects 502, and the data operation 304 can be within the set of protected data operations 504. In such case, the electronic request 106 can be prevented and/or prohibited from execution/performance, unless the electronic request 106 satisfies the MAV rule 402.

In some cases, the MAV rule 402 can apply to and/or otherwise govern any one of the set of tenant partitions 202. In other words, the set of protected data objects 502 can collectively be stored in a single tenant partition of the set of tenant partitions 202 (e.g., can all belong to a single tenant/client). In such cases, different tenant partitions can be governed by different MAV rules. In other cases, however, the MAV rule 402 can apply to and/or otherwise govern two or more of the set of tenant partitions 202. That is, the set of protected data objects 502 can collectively be stored in two or more tenant partitions of the set of tenant partitions 202 (e.g., can collectively belong to two or more tenants/clients). In such cases, the MAV rule 402 can be considered as being implemented in a multi-tenancy fashion.

Although not explicitly shown in the figures, the rule component 114 can electronically store, electronically maintain, and/or otherwise electronically access a plurality of MAV rules. In various instances, each of such plurality of MAV rules can specify its own set of protected data objects (e.g., different MAV rules can protect the same and/or different numbers and/or types of data objects as each other), can specify its own set of protected data operations (e.g., different MAV rules can protect the same and/or different numbers and/or types of data operations as each other), can specify its own threshold number of approvals (e.g., different MAV rules can require the same and/or different numbers of electronic approvals as each other), can specify its own set of approver credentials (e.g., different MAV rules can identify the same and/or different approver credentials as each other), can specify its own request expiration timespan (e.g., different MAV rules can identify the same and/or different request expiration timespans as each other), can specify its own set of executor credentials (e.g., different MAV rules can identify the same and/or different executor credentials as each other), can specify its own approved state expiration timespan (e.g., different MAV rules can identify the same and/or different approved state expiration timespans as each other), and/or can specify its own permissible number of executions (e.g., different MAV rules can identify the same and/or different numbers of permissible executions as each other). In such case, the rule component 114 can electronically select whichever MAV rule from such plurality applies to and/or protects the data object 302 from the data operation 304, and such selected MAV rule can be considered as the MAV rule 402. In other words, the rule component 114 can electronically search through and/or query the plurality of MAV rules until it finds an MAV rule whose set of protected data objects includes the data object 302 and whose set of protected data operations includes the data operation 304, and such found MAV rule can be considered as the MAV rule 402.

In various embodiments, the MAV rule 402 can be electronically generated in any suitable fashion as desired. For example, in some cases, the MAV rule 402 can be generated based on user-provided input. For instance, a tenant/client of the data store 104 can provide input (e.g., via any suitable input device, such as a keyboard, keypad, and/or touchscreen) to the rule component 114, and such input can identify: which and/or how many data objects to include in the set of protected data objects 502; which and/or how many data operations to include in the set of protected data operations 504; the magnitude of the threshold number of approvals 508; which and/or how many credentials to include in the set of approver credentials 506; the magnitude of the request expiration timespan 512; which and/or how many credentials to include in the set of executor credentials 510; the magnitude of the approved state expiration timespan 514; and/or the magnitude of the permissible number of executions 516. As another example, in other cases, the MAV rule 402 can be generated based on inherited default values. For instance, if the tenant/client fails to provide input identifying which and/or how many data objects to include in the set of protected data objects 502, then the set of protected data objects 502 can include all data objects stored within a tenant partition that corresponds to that tenant/client. Moreover, if the tenant/client fails to provide input identifying which and/or how many data operations to include in the set of protected data operations 504, then the set of protected data operations 504 can include all data operations that are implementable within the tenant partition that corresponds to that tenant/client. Furthermore, if the tenant/client fails to provide input identifying the magnitude of the threshold number of approvals 508, then the threshold number of approvals 508 can be given any suitable default magnitude (e.g., at least three approvals). Further still, if the tenant/client fails to provide input identifying the magnitude of the request expiration timespan 512 and/or the approved state expiration timespan 514, then the request expiration timespan 512 and/or the approved state expiration timespan 514 can be given any suitable default magnitudes (e.g., two weeks until expiration). In still other cases, if the tenant/client fails to provide input identifying the magnitude of the permissible number of executions 516, then the permissible number of executions 516 can be given any suitable default magnitude (e.g., one permissible execution).

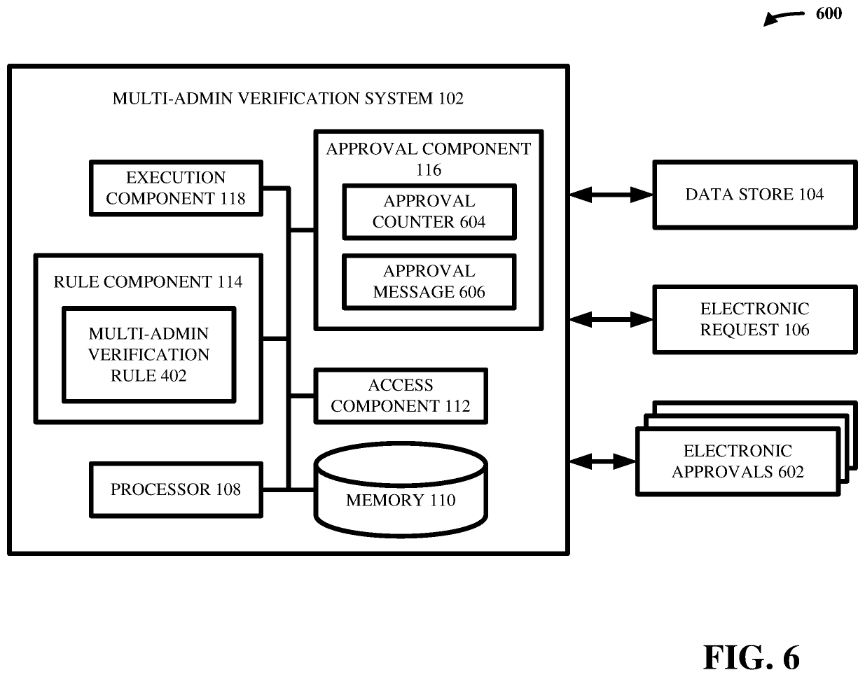

FIG. 6 illustrates a block diagram of an example, non-limiting system 600 including a set of electronic approvals, an approval counter, and/or an approval message that can facilitate multi-admin verification for improved security of data stores in accordance with one or more embodiments described herein. As shown, the system 600 can, in some cases, comprise the same components as the system 400, and can further comprise a set of electronic approvals 602, an approval counter 604, and/or an approval message 606.

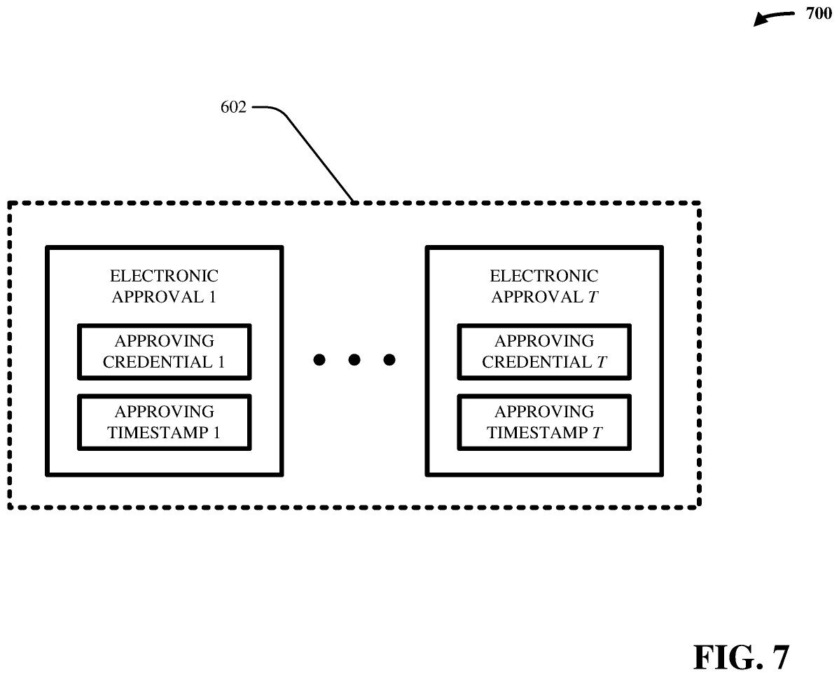

In various embodiments, the access component 112 can electronically receive, retrieve, obtain, and/or otherwise access, from any suitable computing devices (not shown), the set of electronic approvals 602. In various aspects, the set of electronic approvals 602 can include any suitable number of electronic approvals, each corresponding to the electronic request 106 and indicating an approving credential and/or an approving timestamp. This is shown more with respect to FIG. 7.

FIG. 7 illustrates an example, non-limiting block diagram 700 of a set of electronic approvals in accordance with one or more embodiments described herein. That is, FIG. 7 depicts a non-limiting, example embodiment of the set of electronic approvals 602.

As shown, the set of electronic approvals 602 can include t approvals for any suitable positive integer t: an electronic approval 1 to an electronic approval t. In various aspects, each of the set of electronic approvals 602 can be any suitable electronic data that serves as an apparent approval (e.g., as a vote of approval) for the electronic request 106, that specifies the credential that issued and/or otherwise generated the electronic approval, and/or that specifies a time/date on which the electronic approval was issued/generated. For example, the electronic approval 1 can specify an approving credential 1 and/or an approving timestamp 1. In various instances, the approving credential 1 can be any suitable username, password, and/or electronic profile that issued/generated the electronic approval 1 (e.g., that has voted to approve the electronic request 106). In various cases, the approving timestamp 1 can indicate the time/date at which the approving credential 1 issued/generated the electronic approval 1. Likewise, the electronic approval t can specify an approving credential t and/or an approving timestamp t. In Just as above, the approving credential t can be any suitable username, password, and/or electronic profile that issued/generated the electronic approval t (e.g., that has voted to approve the electronic request 106), and/or the approving timestamp t can indicate the time/date at which the approving credential t issued/generated the electronic approval t.

For purposes of illustration and explanation, a non-limiting example of an electronic approval written in XML syntax is presented below.

Line 1 <?xml version=“1.0”?>
Line 2 < MAV Approval>

| | |
|---|---|
| Line 3 | <title> Example Electronic Approval for Multi-Admin Verification</title> |
| Line 4 | <target request> Example Request Identifier </target request> |
| Line 5 | <credentials> |
| Line 6 | <user> Admin 1 </user> |
| Line 7 | <password> @2ov#g]esc\hat{ }CwAA5;q,L</password> |
| Line 8 | </credentials> |
| Line 9 | <approval timestamp> 07112022:134505 </approval timestamp> |

Line 10 </MAV Approval>

In such non-limiting example, Line 1 can be considered as denoting or specifying an XML syntax version in which the non-limiting example of the electronic approval is written, and Lines 2-10 can be considered as denoting or specifying the contents of the non-limiting example of the electronic approval. In various aspects, Line 3 can be considered as denoting or specifying a title of the non-limiting example of the electronic approval. In this particular illustration, the non-limiting example of the electronic approval can be entitled “Example Electronic Approval for Multi-Admin Verification”.

In various aspects, Line 4 can be considered as denoting or specifying whichever request at which the Example Electronic Approval for Multi-Admin Verification is targeted. That is, Line 4 can indicate or otherwise identify the specific electronic request that the Example Electronic Approval for Multi-Admin Verification is attempting to approve.

In various instances, Lines 5-8 can be considered as denoting or specifying the credential or identifier of the particular entity that generated the Example Electronic Approval for Multi-Admin Verification. As shown in this particular illustration, the Example Electronic Approval for Multi-Admin Verification can have been generated by the Admin 1.

In various cases, Line 9 can be considered as denoting or specifying a timestamp associated with the Example Electronic Approval for Multi-Admin Verification. That is, Line 9 can indicate or otherwise identify when the Example Electronic Approval for Multi-Admin Verification was generated by the Admin 1.

Referring back to FIG. 6, the approval component 116 can electronically analyze the set of electronic approvals 602 to determine whether or not the electronic request 106 can enter the approved state. More specifically, the approval component 116 can electronically initialize the approval counter 604, which can be a dummy variable and/or a dummy scalar with an initial magnitude of zero. In various aspects, the approval component 116 can iterate through each of the set of electronic approvals 602. For each given electronic approval, the approval component 116 can determine whether the given electronic approval satisfies the requirements and/or prohibitions of the MAV rule 402 (e.g., prohibition against unauthorized approvals, prohibition against untimely approvals, prohibition against self-approvals). If not, the approval component 116 can discard, disregard, and/or reject the given electronic approval as invalid. On the other hand, if so, the approval component 116 can accept the given electronic approval as valid, and the approval component 116 can increment the approval counter 604 by one. When and/or if the approval counter 604 satisfies the threshold number of approvals 508, the approval component 116 can mark the electronic request 106 as being in the approved state. In any case, based on having analyzed the set of electronic approvals 602 for compliance with the MAV rule 402, the approval component 116 can electronically generate the approval message 606, which can be any suitable electronic message that indicates (e.g., textually) whether or not the electronic request 106 has entered the approved state. In some cases, the approval component 116 can electronically render the approval message 606 on any suitable computer screen/display. In other cases, the approval component 116 can electronically transmit the approval message 606 to any suitable computing device as desired.

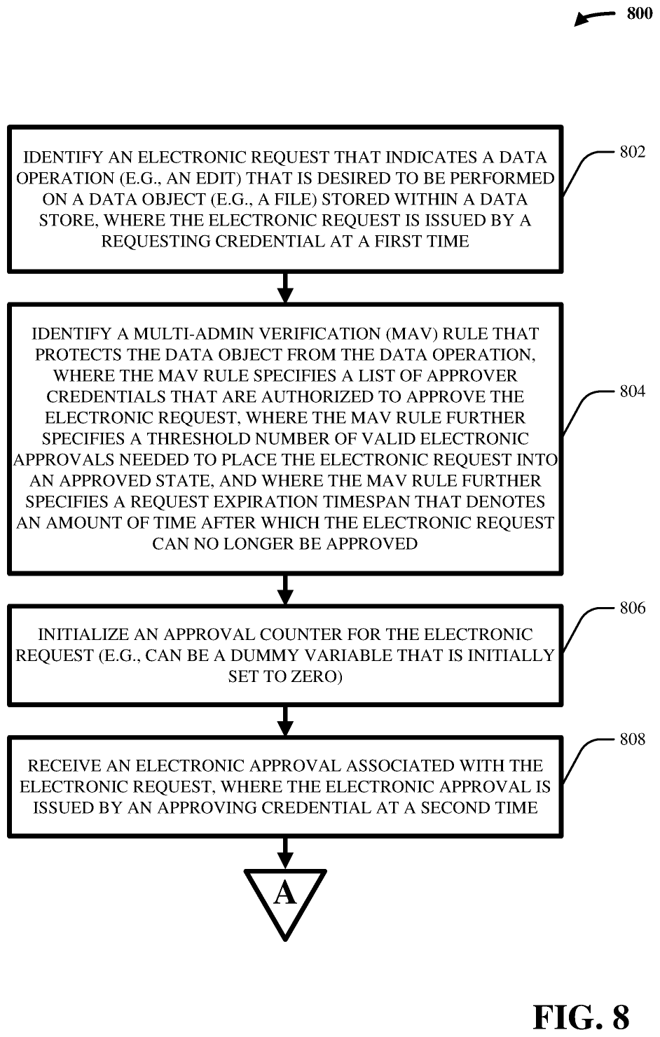

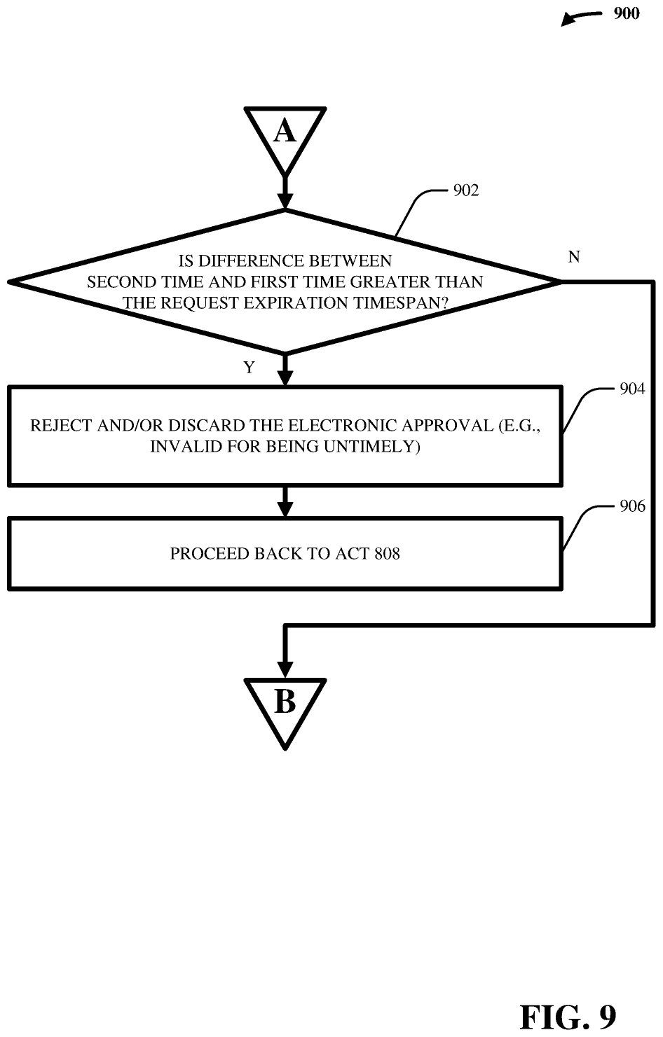

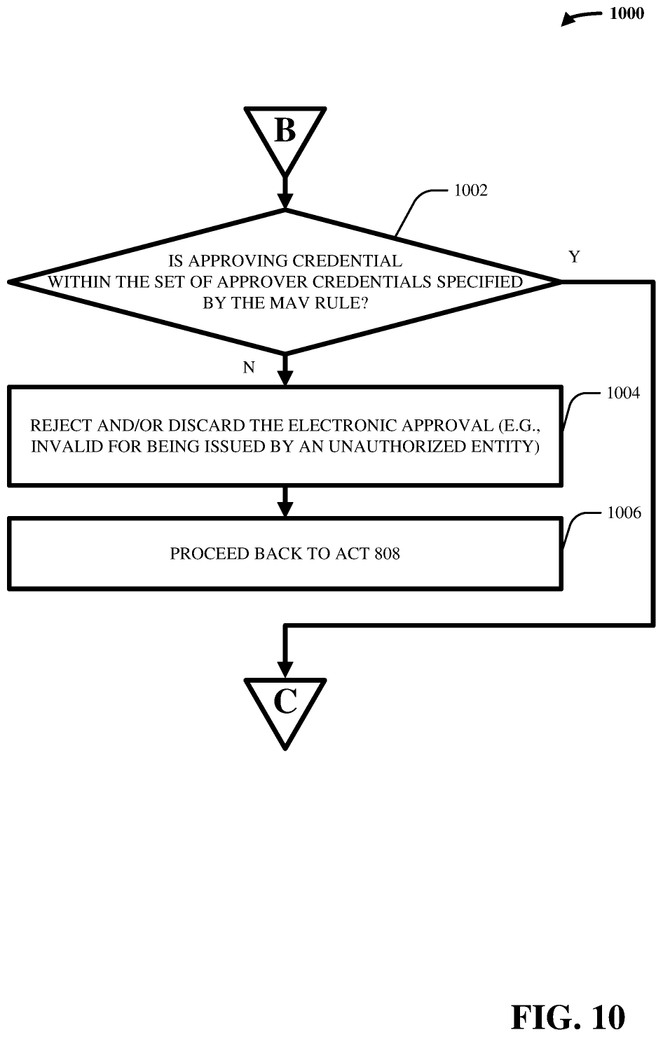

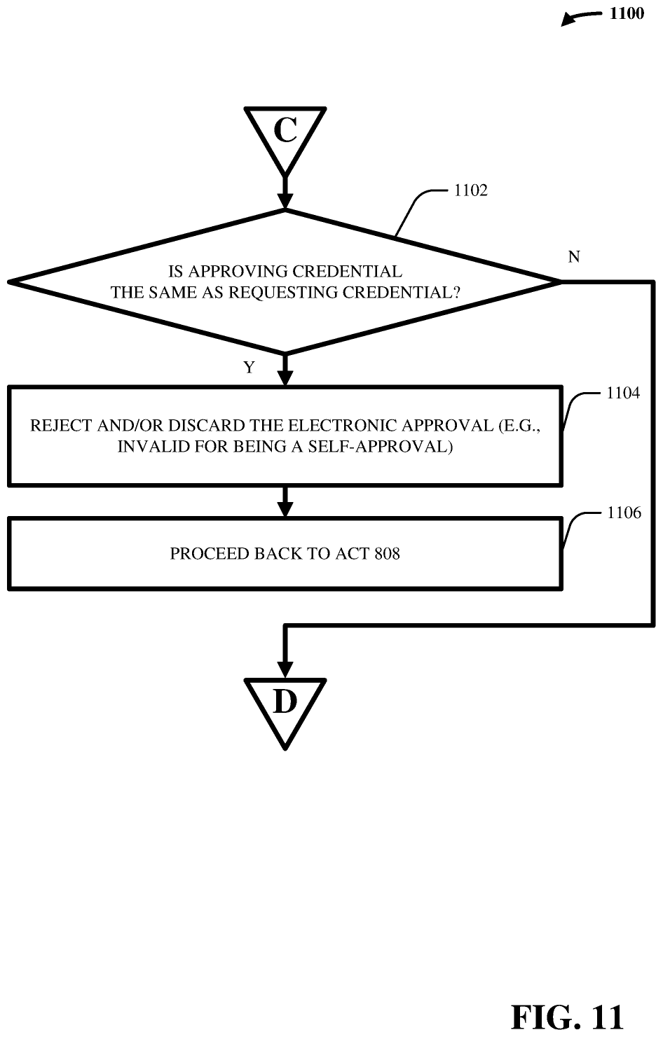

For further clarification, the iterative analysis performed by the approval component 116 is described more with respect to FIGS. 8-12.

FIGS. 8-12 illustrate flow diagrams of example, non-limiting computer-implemented methods 800, 900, 1000, 1100, and 1200 that can facilitate approval of an electronic request according to multi-admin verification for improved security of data stores in accordance with one or more embodiments described herein.

First, consider the computer-implemented method 800. In various embodiments, act 802 can include identifying, by a device (e.g., via 112) operatively coupled to a processor, an electronic request (e.g., 106) that indicates a data operation (e.g., 304) that is desired to be performed on a data object (e.g., 302) stored within a data store (e.g., 104). In various cases, the electronic request can be issued by a requesting credential (e.g., 306) at a first time (e.g., indicated by 308).

In various aspects, act 804 can include identifying, by the device (e.g., via 114), a multi-admin verification (MAV) rule (e.g., 402) that protects the data object from the data operation. In various cases, the MAV rule can specify: a list of approver credentials (e.g., 506) that are authorized to approve the electronic request; a threshold number (e.g., 508) of valid electronic approvals needed to place the electronic request into an approved state; and/or a request expiration timespan (e.g., 512) that denotes an amount of time after which the electronic request can no longer be approved and/or otherwise enter the approved state.

In various instances, act 806 can include initializing, by the device (e.g., via 116), an approval counter (e.g., 604) for the electronic request. In various cases, such approval counter can be a dummy variable that is initially set to zero (e.g., indicating zero approvals counted so far).

In various aspects, act 808 can include receiving, by the device (e.g., via 112), an electronic approval (e.g., one of 602) that is associated with the electronic request. In various cases, the electronic approval can be issued by an approval credential (e.g., the approving credential t) at a second time (e.g., indicated by the approving timestamp t). The computer-implemented method 800 can then proceed to act 902 of the computer-implemented method 900.

In various embodiments, act 902 can include determining, by the device (e.g., via 116), whether a difference between the second time (e.g., time/date at which the electronic approval was issued) and the first time (e.g., time/date at which the electronic request was issued) is greater than the request expiration timespan. If so, the computer-implemented method 900 can proceed to act 904. If not, the computer-implemented method 900 can proceed to act 1002 of the computer-implemented method 1000.

In various aspects, act 904 can include rejecting and/or discarding the electronic approval. In other words, at act 904, the electronic approval can be considered as invalid for being untimely (e.g., for being issued after the request expiration timespan has elapsed).

In various instances, act 906 can include proceeding back to act 808 of the computer-implemented method 800.

In various embodiments, act 1002 can include determining, by the device (e.g., via 116), whether the approving credential (e.g., the credential that issued the electronic approval) is within the set of approver credentials specified by the MAV rule. If not, the computer-implemented method 1000 can proceed to act 1004. If so, the computer-implemented method 1000 can proceed to act 1102 of the computer-implemented method 1100.

In various aspects, act 1004 can include rejecting and/or discarding the electronic approval. In other words, at act 1004, the electronic approval can be considered as invalid for being issued by an unauthorized entity (e.g., for being issued by a credential that is not permitted to issue an approval).

In various instances, act 1006 can include proceeding back to act 808 of the computer-implemented method 800.

In various embodiments, act 1102 can include determining, by the device (e.g., via 116), whether the approving credential (e.g., the credential that issued the electronic approval) is the same as (e.g., matches) the requesting credential (e.g., the credential that issued the electronic request). If so, the computer-implemented method 1100 can proceed to act 1104. If not, the computer-implemented method 1100 can proceed to act 1202 of the computer-implemented method 1200.

In various aspects, act 1104 can include rejecting and/or discarding the electronic approval. In other words, at act 1104, the electronic approval can be considered as invalid for being a self-approval (e.g., for being issued by the same credential that issued the electronic request). Note that the electronic approval can be rejected/discarded at act 1104 for being a self-approval, notwithstanding that the approving credential is listed in the set of approver credentials specified by the MAV rule, as verified at act 1002.

In various instances, act 1106 can include proceeding back to act 808 of the computer-implemented method 800.

In various embodiments, act 1202 can include accepting and/or deeming, by the device (e.g., via 116) the electronic approval as valid, and incrementing, by the device (e.g., via 116), the approval counter by one.

In various aspects, act 1204 can include determining, by the device (e.g., via 116), whether the approval counter is now greater than or equal to the threshold number of valid electronic approvals needed to place the electronic request into the approved state, as specified by the MAV rule. If not, the computer-implemented method 1200 can proceed to act 1206. On the other hand, if so, the computer-implemented method 1200 can proceed to act 1208.

In various instances, act 1206 can include proceeding back to act 808 of the computer-implemented method 800.

In various cases, act 1208 can include marking, by the device (e.g., via 116) the electronic request as now being in the approved state.

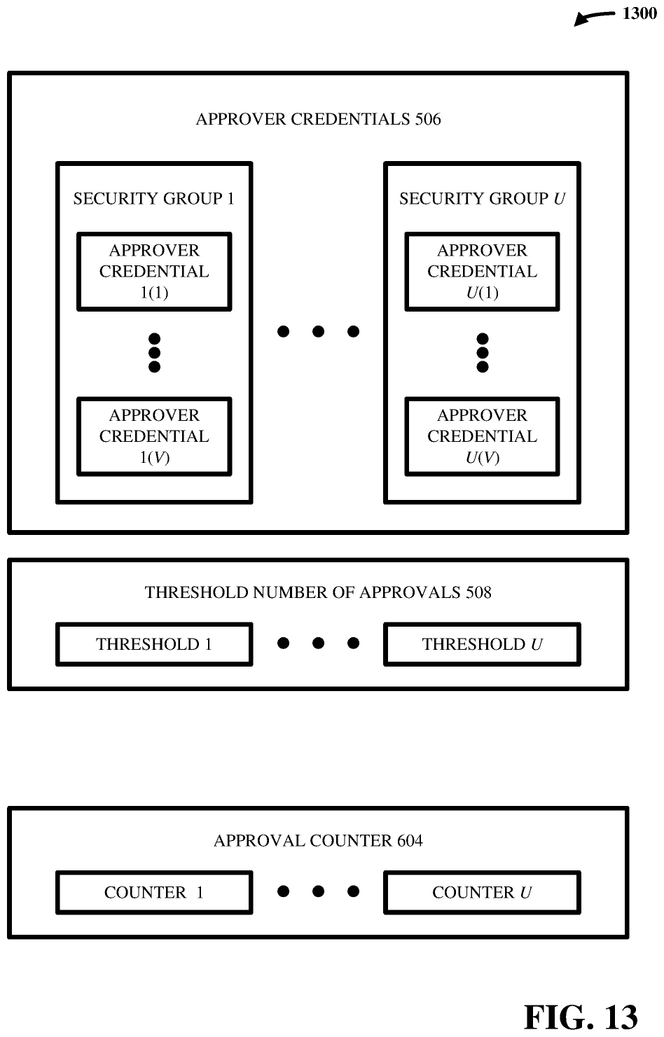

Thus far, the herein-disclosure has mainly described various embodiments in which the set of approver credentials 506 is treated as being monolithic and/or as uni-tiered. In various cases, however, the set of approver credentials 506 can be multi-tiered and/or otherwise stratified into subgroups according to security clearance levels. This is explained more with respect to FIG. 13.

FIG. 13 illustrates an example, non-limiting block diagram 1300 of a multi-tiered set of approver credentials in accordance with one or more embodiments described herein. That is, FIG. 13 depicts a non-limiting, example embodiment of the set of approver credentials 506 that is stratified into subgroups according to security clearance level.

In various embodiments, as shown, the set of approver credentials 506 can be organized into u separate security groups for any suitable positive integer u: a security group 1 to a security group u. In various aspects, each security group can include any suitable number of approver credentials that correspond to a respective security clearance level. For instance, the security group 1 can correspond to a first (e.g., lowest) security clearance level and can include v approver credentials for any suitable positive integer v: an approver credential 1(1) to an approver credential 1(v). Likewise, the security group u can correspond to a u-th (e.g., highest) security clearance level and can include v approver credentials for any suitable positive integer v: an approver credential u(1) to an approver credential u(v). Although FIG. 13 depicts each of the security groups as having the same number of approver credentials as each other (e.g., v), this is a mere non-limiting example for ease of illustration. Those having ordinary skill in the art will appreciate that different security groups can have the same and/or different approver credentials as each other.

As a non-limiting example, suppose that there are four security groups (e.g., suppose that u=4): a first security group corresponding to a lowest security clearance level; a second security group corresponding to a low-intermediate security clearance level; a third security group corresponding to a high-intermediate security clearance level; and a fourth security group corresponding to a highest security clearance level. In such case, the first security group can list one or more credentials assigned to one or more rank-and-file employees of a tenant/client, the second security group can list one or more credentials assigned to one or more managers/supervisors of the tenant/client, the third security group can list one or more credentials assigned to one or more board members of the tenant/client, and/or the fourth security group can list one or more credentials assigned to one or more executive officers of the tenant/client.

In various aspects, because the set of approver credentials 506 can be stratified and/or tiered according to the u different security groups, the threshold number of approvals 508 can be correspondingly stratified and/or tiered. That is, rather than being a scalar, the threshold number of approvals 508 can be a u-element vector, where each element of such vector can be a scalar that indicates a threshold number of electronic approvals needed from a respectively corresponding security group in order for the electronic request 106 to enter the approved state. For example, the threshold number of approvals 508 can include a threshold 1 to a threshold u, where the threshold 1 can indicate how many distinct electronic approvals are required from credentials listed in the security group 1 for the electronic request 106 to be placed into the approved state, and/or where the threshold u can indicate how many distinct electronic approvals are required from credentials listed in the security group u for the electronic request 106 to be placed into the approved state.

In some aspects, the u thresholds can be cumulative with each other. That is, in such cases, each of the u thresholds can have to be satisfied in order for the electronic request 106 to enter the approved state. For instance, consider again the above non-limiting example involving four security groups. In order for the electronic request 106 to enter the approved state, it can be required to have three valid approvals from the first security group, and one valid approval from the second security group, and one valid approval from the third security group, and two valid approvals from the fourth security group, thereby yielding a required total of seven valid approvals. In other aspects, however, the u thresholds can be alternative with each other. That is, in such cases, any single one of the u thresholds can have to be satisfied in order for the electronic request 106 to enter the approved state. For instance, consider again the above non-limiting example involving four security groups. In order for the electronic request 106 to enter the approved state, it can be required to have three valid approvals from the first security group, or one valid approval from the second security group, or one valid approval from the third security group, or two valid approvals from the fourth security group. In such case, a total of seven valid approvals would not be needed for the electronic request 106 to enter the approved state. In still other aspects, more than one but fewer than all of the u thresholds can have to be satisfied in order for the electronic request 106 to enter the approved state. For instance, consider again the above non-limiting example involving four security groups. In order for the electronic request 106 to enter the approved state, it can be required to have three valid approvals from the first security group and one valid approval from the second security group (e.g., for a total of four valid approvals), or it can be required to have one valid approval from the third security group and two valid approvals from the fourth security group (e.g., for a total of three valid approvals).

In any case, because the set of approver credentials 506 and the threshold number of approvals 508 can be stratified into u tiers, the approval counter 604 can likewise be stratified into u tiers. More specifically, the approval counter 604 can include u separate counters (e.g., a counter 1 to a counter u), each of which can be configured to keep track of approvals from a respectively corresponding security group. For example, the counter 1 can be configured to keep track how many electronic approvals are issued by credentials from the security group 1 (e.g., accordingly, the counter 1 can be compared against the threshold 1), and the counter u can be configured to keep track how many electronic approvals are issued by credentials from the security group u (e.g., accordingly, the counter u can be compared against the threshold u).

For purposes of illustration and explanation, a non-limiting example of the MAV rule 402 in accordance with FIG. 13 and written in XML syntax is presented below.

Line 1 <?xml version=“1.0”?>
Line 2 <MAV rule>

| | |
|---|---|
| Line 3 | <title> Example MAV Rule with Stratified Approval Groups </title> |
| Line 4 | <data objects> |
| Line 5 | <file>filename.docx</file> |
| Line 6 | <object store>s3.example_target.myquobyte.net</object store> |
| Line 7 | <NoSQL>https://www.patentex.com/testdb/20493/></NoSQL> |
| Line 8 | </data objects> |
| Line 9 | <operations> |
| Line 10 | <operation>write</operation> |
| Line 11 | <operation>erase</operation> |
| Line 12 | </operations> |
| Line 13 | <approver group 1> |
| Line 14 | <user>Admin 1</user> |
| Line 15 | <user>Admin 2</user> |
| Line 16 | <user>Admin 3</user> |
| Line 17 | <user>Admin 4</user> |
| Line 18 | </approver group 1> |
| Line 19 | <approver group 2> |
| Line 20 | <user>Admin 5</user> |
| Line 21 | <user>Admin 6</user> |
| Line 22 | <user>Admin 7</user> |
| Line 23 | </approver group 2> |
| Line 24 | <executor> |
| Line 25 | <user>Admin 1</user> |
| Line 26 | <user>Admin 4</user> |
| Line 27 | </executor> |
| Line 28 | <request expiration time>15</request expiration time> |
| Line 29 | <approved expiration time>10</approved expiration time> |
| Line 30 | <approval threshold 1>3</approval threshold 1> |
| Line 31 | <approval threshold 2>2</approval threshold 2> |
| Line 32 | <disjunctive approvals> No </disjunctive approvals> |
| Line 33 | <number executions>3</number executions> |
| Line 34 | <self-approval>no</self-approval> |
| Line 35 | <self-execution>no</self-execution> |

Line 36 </MAV rule>

In such non-limiting example, Line 1 can be considered as denoting or specifying an XML syntax version in which the non-limiting example of the MAV rule 402 is written, and Lines 2-36 can be considered as denoting or specifying the contents of the non-limiting example of the MAV rule 402. In various aspects, Line 3 can be considered as denoting or specifying a title of the non-limiting example of the MAV rule 402. In this particular illustration, the non-limiting example of the MAV rule 402 can be entitled “Example MAV Rule with Stratified Approval Groups”.

In various instances, Lines 4-8 can be considered as denoting or specifying the particular data objects that are protected by the Example MAV Rule with Stratified Approval Groups, similar to as already described above.

In various cases, Lines 9-12 can be considered as denoting or specifying the particular data operations that are governed by the Example MAV Rule with Stratified Approval Groups, similar to as already described above.

In various cases, Lines 13-23 can be considered as denoting or specifying the credentials or identifiers of the particular entities that are allowed to approve a request to perform any of the set of protected data operations 504 on any of the set of protected data objects 502, where such entities can be stratified into multiple approval groups. In particular, the Example MAV Rule with Stratified Approval Groups can specify a first approval group (e.g., denoted by Lines 13-18) and a second approval group (e.g., denoted by Lines 19-23). In other words, Lines 13-23 can be considered as indicating the set of approver credentials 506 as shown in FIG. 13, with u=2. As shown in this particular illustration, the Example MAV Rule with Stratified Approval Groups can specify that the Admin 1 (e.g., denoted by Line 14), the Admin 2 (e.g., denoted by Line 15), the Admin 3 (e.g., denoted by Line 16), and the Admin 4 are in the first approval group. As also shown in this particular illustration, the Example MAV Rule with Stratified Approval Groups can specify that an Admin 5 (e.g., denoted by Line 20), an Admin 6 (e.g., denoted by Line 21), and an Admin 7 (e.g., denoted by Line 22) are in the second approval group.

In various aspects, Lines 24-27 can be considered as denoting or specifying the credentials or identifiers of the particular entities that are allowed to execute an approved request to perform any of the set of protected data operations 504 on any of the set of protected data objects 502, similar to as already described above.

In various instances, Line 28 can be considered as denoting or otherwise specifying an amount of time during which a request to perform any of the set of protected data operations 504 on any of the set of protected data objects 502 can be approved by the set of approver credentials 506, similar to as already described above.

In various cases, Line 29 can be considered as denoting or otherwise specifying an amount of time during which an approved request to perform any of the set of protected data operations 504 on any of the set of protected data objects 502 can be executed by the set of executor credentials 510, similar to as already described above.

In various aspects, Line 30 can be considered as denoting or otherwise specifying how many valid electronic approvals from the first approval group are needed to approve a request to perform any of the set of protected data operations 504 on any of the set of protected data objects 502. Likewise, Line 31 can be considered as denoting or otherwise specifying how many valid electronic approvals from the second approval group are needed to approve a request to perform any of the set of protected data operations 504 on any of the set of protected data objects 502. That is, Lines 30-31 can be considered as indicating the threshold number of approvals 508 in accordance with FIG. 13. As shown in this non-limiting illustration, the first approval threshold can be 3, while the second approval threshold can be 2. That is, any three of the Admin 1, the Admin 2, the Admin 3, or the Admin 4, and/or any two of the Admin 5, the Admin 6, or the Admin 7 can be required to place the request into an approved state. Although not explicitly shown, Lines 30-31 can be implemented with any suitable counters or trackers that can be incremented as valid electronic approvals are received from the stratified approval groups.

In various instances, Line 32 can be considered as denoting or otherwise specifying whether the approval thresholds of the stratified approval groups work conjunctively or disjunctively. If the approval thresholds of the stratified approval groups work conjunctively, then all of the approval thresholds of the stratified approval groups should be satisfied in order to place the request into the approved state (e.g., approvals from any three of the Admins 1-4 AND any two of the Admins 5-7 are needed to place the request into the approved state). On the other hand, if the approval thresholds of the stratified approval groups work disjunctively, then any (e.g., fewer than all) of the approval thresholds of the stratified approval groups should be satisfied in order to place the request into the approved state (e.g., approvals from any three of the Admins 1-4 OR any two of the Admins 5-7 are needed to place the request into the approved state).

In various instances, Line 33 can be considered as denoting or otherwise specifying how many times a request to perform any of the set of protected data operations 504 on any of the set of protected data objects 502 can be executed upon entering the approved state, similar to as already described above.

In various cases, Line 34 can be considered as denoting or otherwise specifying that self-approvals are impermissible, similar to as already described above.

In various aspects, Line 35 can be considered as denoting or otherwise specifying that self-executions are impermissible, similar to as already described above.

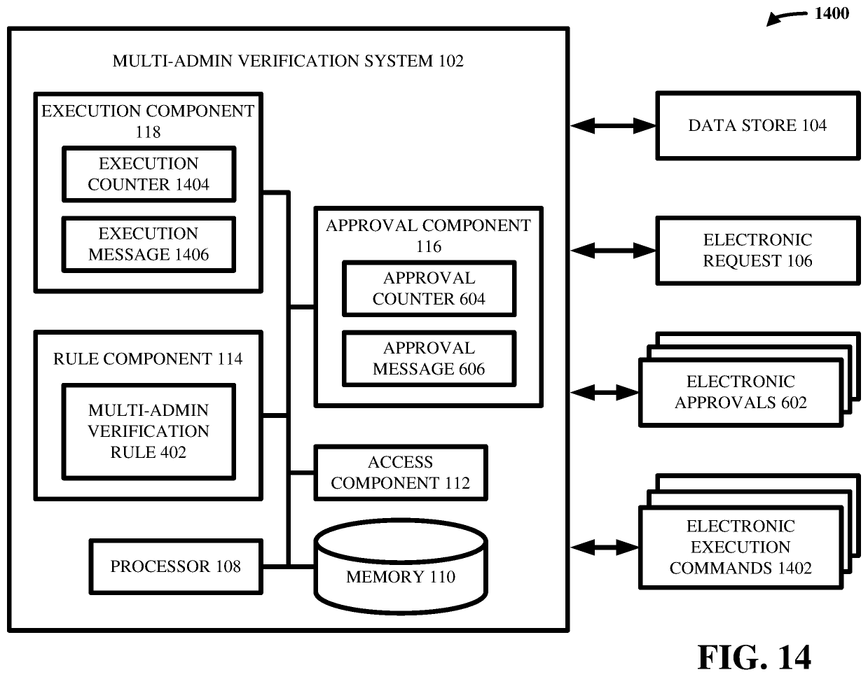

FIG. 14 illustrates a block diagram of an example, non-limiting system 1400 including a set of electronic execution commands, an execution counter, and/or an execution message that can facilitate multi-admin verification for improved security of data stores in accordance with one or more embodiments described herein. In various cases, as shown, the system 1400 can comprise the same components as the system 600, and can further comprise a set of electronic execution commands 1402, an execution counter 1404, and/or an execution message 1406.

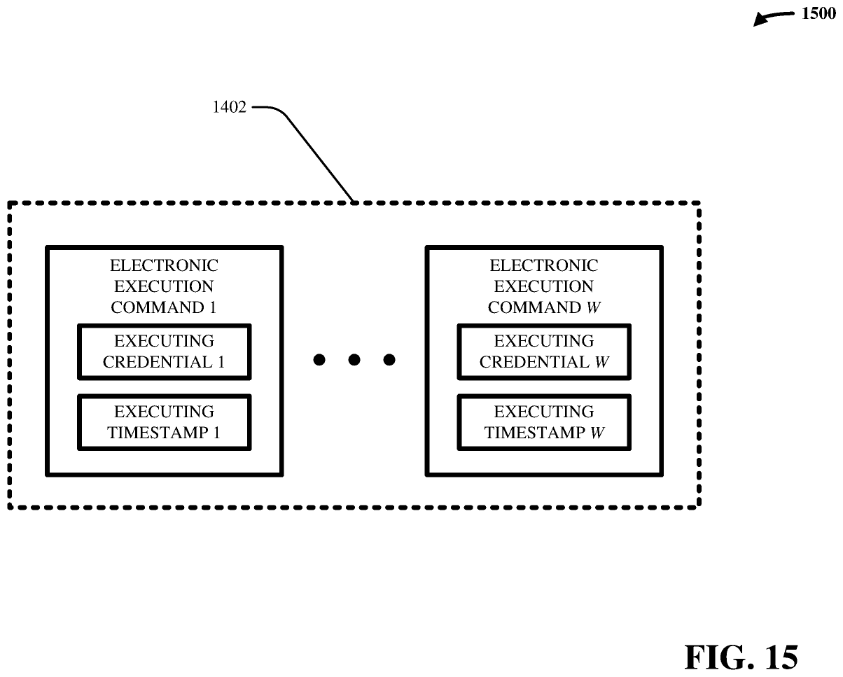

In various embodiments, based on the electronic request 106 entering the approved state, the access component 112 can electronically receive, retrieve, obtain, and/or otherwise access, from any suitable computing devices (not shown), the set of electronic execution commands 1402. In various aspects, the set of electronic execution commands 1402 can include any suitable number of electronic execution commands, each corresponding to the electronic request 106 and indicating an executing credential and/or an executing timestamp. This is shown more with respect to FIG. 15.

FIG. 15 illustrates an example, non-limiting block diagram 1500 of a set of electronic execution commands in accordance with one or more embodiments described herein. That is, FIG. 15 depicts a non-limiting, example embodiment of the set of electronic execution commands 1402.

As shown, the set of electronic execution commands 1402 can include w approvals for any suitable positive integer w: an electronic execution command 1 to an electronic execution command w. In various aspects, each of the set of electronic execution commands 1402 can be any suitable electronic data that serves as an instruction to perform and/or execute the electronic request 106, that specifies the credential that issued and/or otherwise generated the electronic execution command, and/or that specifies a time/date on which the electronic execution command was issued/generated. For example, the electronic execution command 1 can specify an executing credential 1 and/or an executing timestamp 1. In various instances, the executing credential 1 can be any suitable username, password, and/or electronic profile that issued/generated the electronic execution command 1. In various cases, the executing timestamp 1 can indicate the time/date at which the executing credential 1 issued/generated the electronic execution command 1. Likewise, the electronic execution command w can specify an executing credential w and/or an executing timestamp w. Just as above, the executing credential w can be any suitable username, password, and/or electronic profile that issued/generated the electronic execution command w, and/or the executing timestamp w can indicate the time/date at which the executing credential w issued/generated the electronic execution command w.

Referring back to FIG. 14, the execution component 118 can electronically analyze the set of electronic execution commands 1402 to determine whether or not the electronic request 106 can be executed/performed. More specifically, the execution component 118 can electronically initialize the execution counter 1404, which can be a dummy variable and/or a dummy scalar with an initial magnitude of zero. In various aspects, the execution component 118 can iterate through each of the set of electronic execution commands 1402. For each given electronic execution command, the execution component 118 can determine whether the given electronic execution command satisfies the requirements and/or prohibitions of the MAV rule 402 (e.g., prohibition against unauthorized execution commands, prohibition against untimely execution commands, prohibition against self-executions). If not, the execution component 118 can discard, disregard, and/or reject the given electronic execution command as invalid. On the other hand, if so, the execution component 118 can accept the given electronic execution command as valid, and the execution component 118 can evaluate the execution counter 1404 to determine whether the electronic request 106 can be executed/performed based on the valid execution command. If the execution counter 1404 is already greater than or equal to the permissible number of executions 516, then the execution component 118 can refrain from executing/performing the electronic request 106. In contrast, if the execution counter 1404 is less than the permissible number of executions 516, then the execution component 118 can execute/perform the electronic request 106 (e.g., can cause the data operation 304 to be applied to the data object 302), and can increment the execution counter 1404 by one. In any case, based on having analyzed the set of electronic execution commands 1402 for compliance with the MAV rule 402, the execution component 118 can electronically generate the execution message 1406, which can be any suitable electronic message that indicates (e.g., textually) whether or not the electronic request 106 has been executed and/or how many times the electronic request 106 has been executed. In some cases, the execution component 118 can electronically render the execution message 1406 on any suitable computer screen/display. In other cases, the execution component 118 can electronically transmit the execution message 1406 to any suitable computing device as desired.

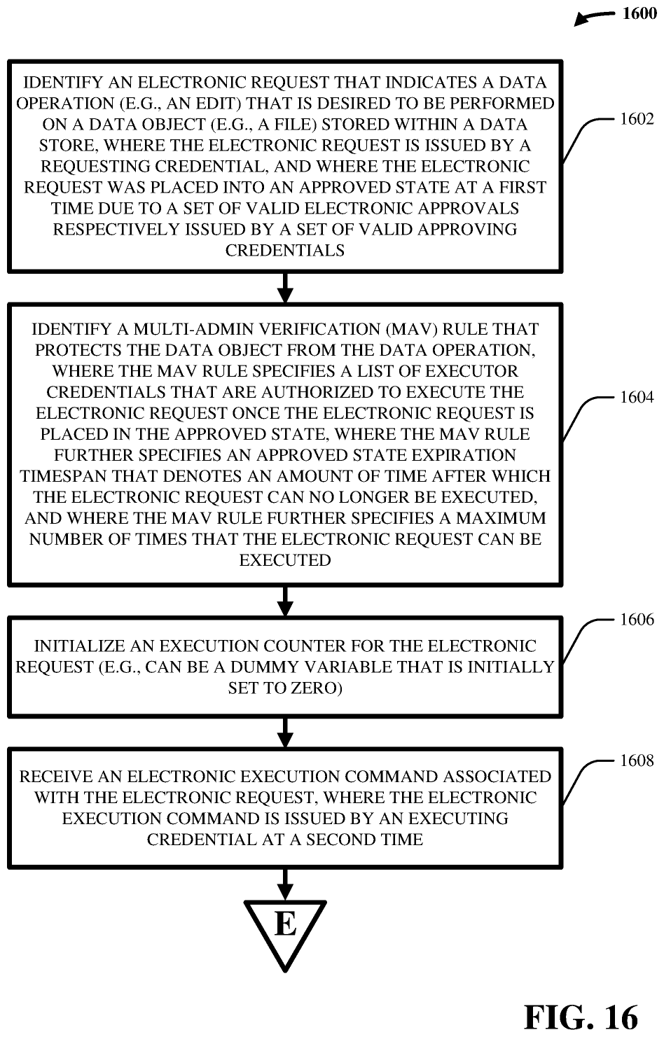

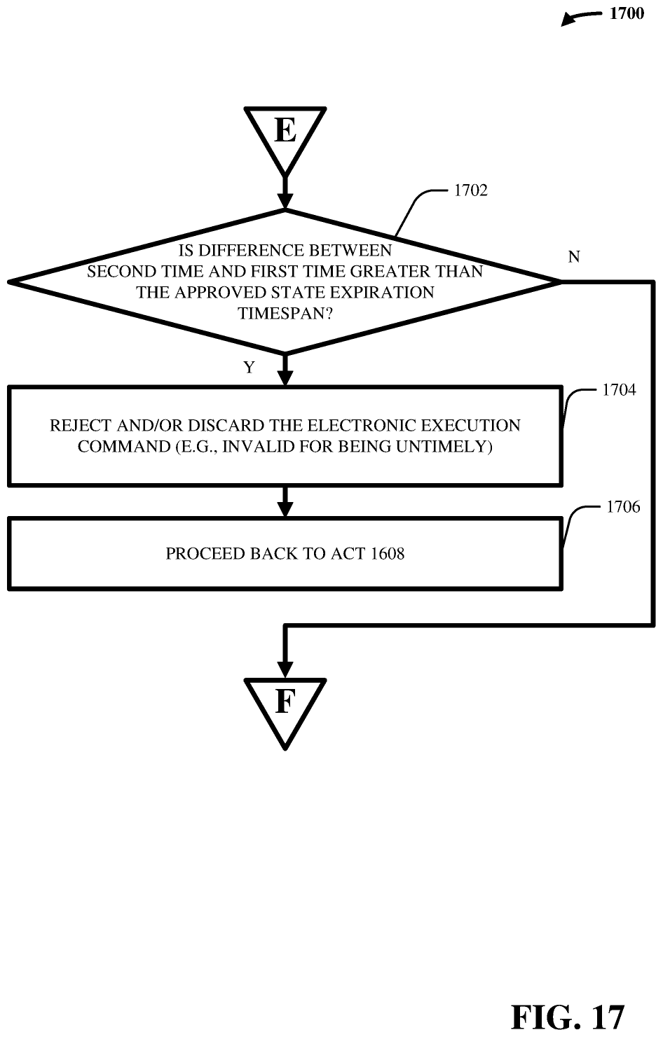

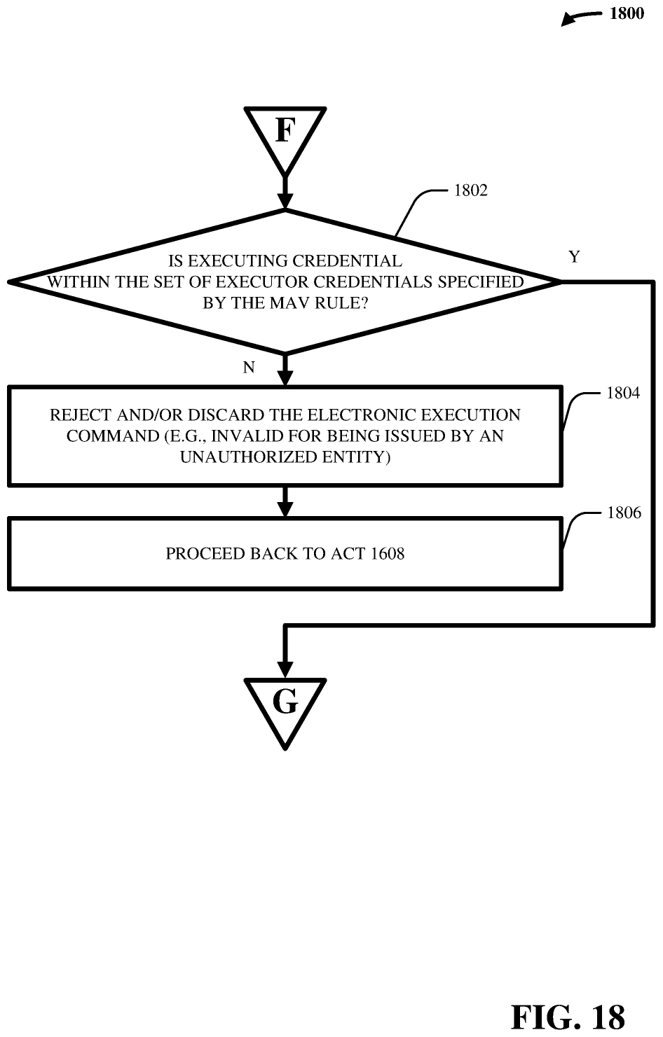

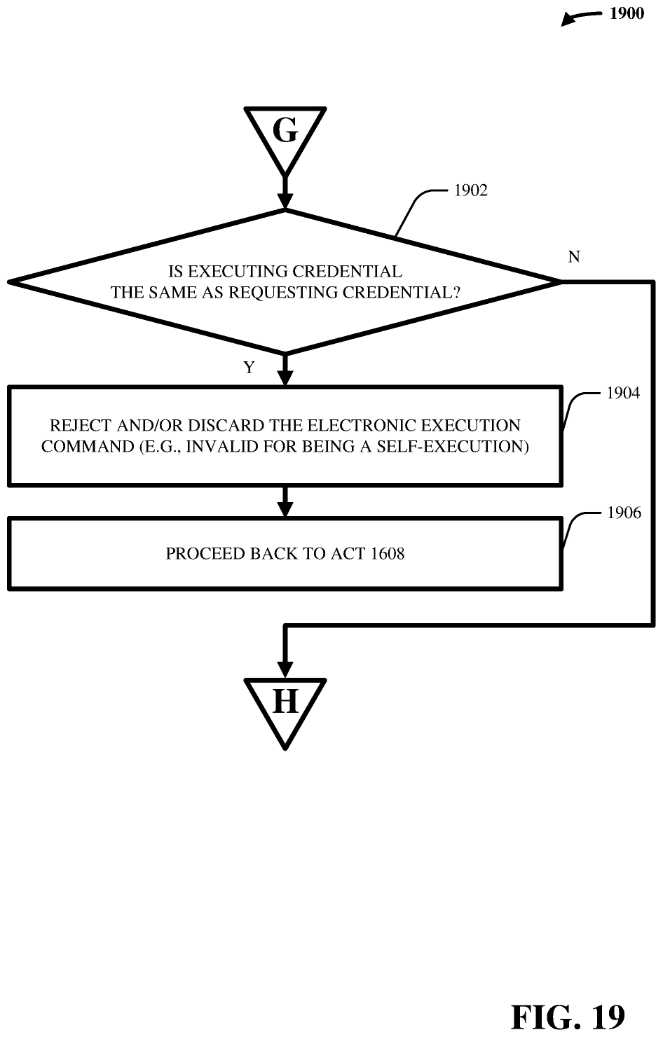

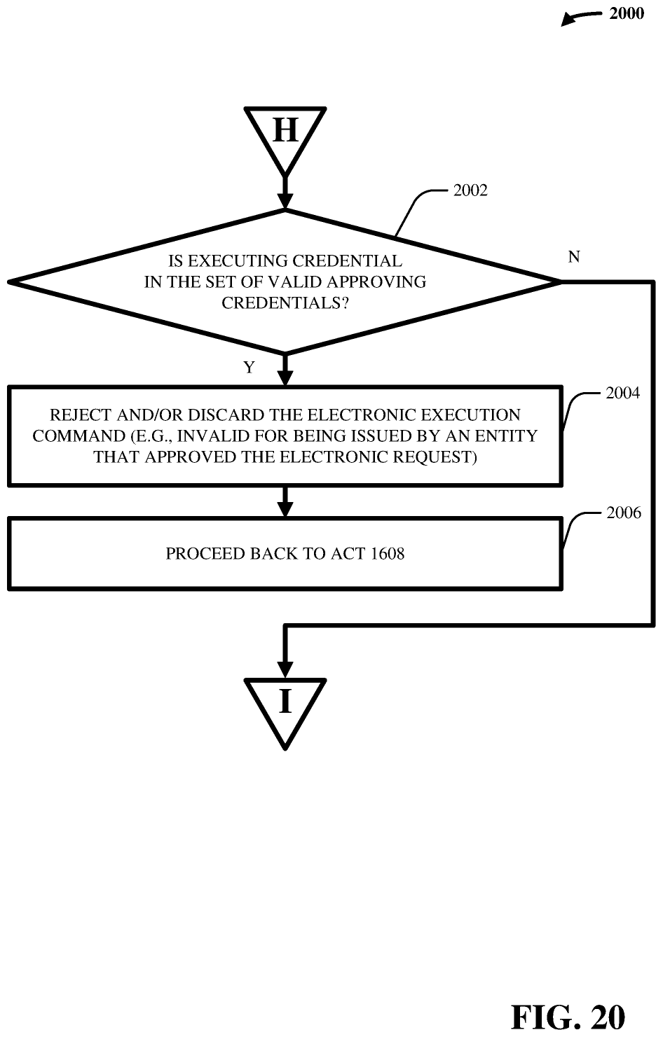

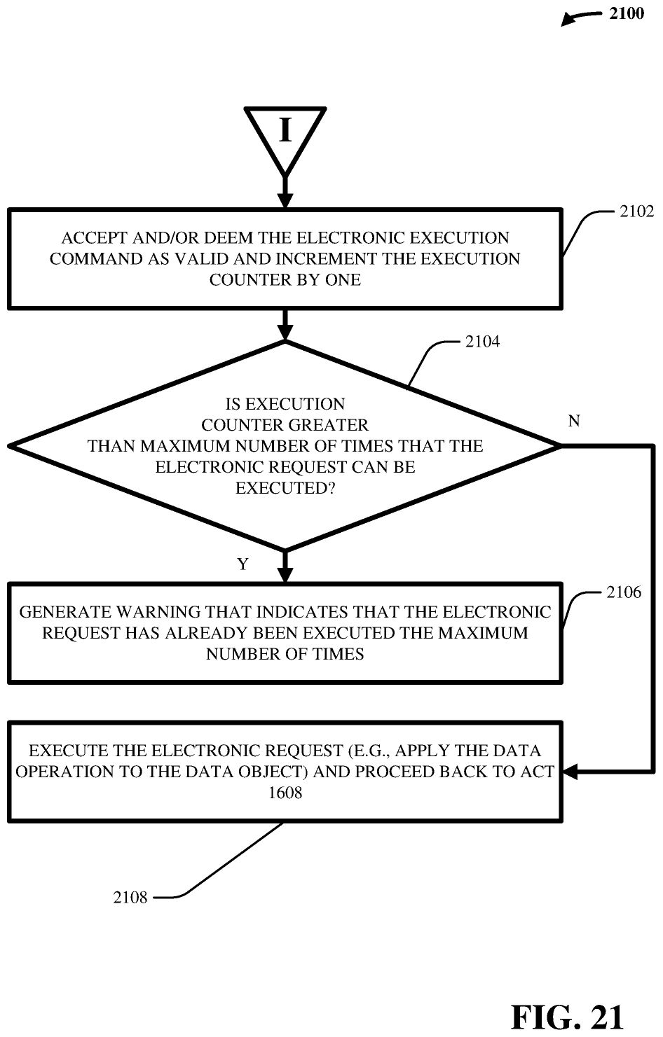

For further clarification, the iterative analysis performed by the execution component 118 is described more with respect to FIGS. 16-21.

FIGS. 16-21 illustrate flow diagrams of example, non-limiting computer-implemented methods 1600, 1700, 1800, 1900, 2000, and 2100 that can facilitate execution of an electronic request according to multi-admin verification for improved security of data stores in accordance with one or more embodiments described herein.

First, consider the computer-implemented method 1600. In various embodiments, act 1602 can include identifying, by a device (e.g., via 112) operatively coupled to a processor, an electronic request (e.g., 106) that indicates a data operation (e.g., 304) that is desired to be performed on a data object (e.g., 302) stored within a data store (e.g., 104). In various cases, the electronic request can be issued by a requesting credential (e.g., 306), and/or the electronic request can have been placed into the approved state at a first time (e.g., time/date at which the approval component 116 marks the electronic request 106 as being in the approved state) due to a set of valid electronic approvals respectively issued by a set of valid approving credentials.

Note that the set of valid approving credentials referred to here is not necessarily the same as the set of approver credentials 506. Instead, the set of valid approving credentials can be a subset of the set of approver credentials 506. This is because the set of approver credentials 506 can be the total set of credentials that are allowed to issue an electronic approval for the electronic request, whereas the set of valid approving credentials can instead be those credentials within the set of approver credentials 506 that actually did issue a valid electronic approval for the electronic request. In other words, it can be possible for some credentials within the set of approver credentials 506 to not issue valid electronic approvals for the electronic request (e.g., they can issue an untimely approval, they can issue a self-approval, and/or they can choose to issue no approval at all). In various cases, those credentials in the set of approver credentials 506 that did not issue a valid electronic approval for the electronic request can be excluded from the set of valid approving credentials.

In various aspects, act 1604 can include identifying, by the device (e.g., via 114), a multi-admin verification (MAV) rule (e.g., 402) that protects the data object from the data operation. In various cases, the MAV rule can specify: a list of executor credentials (e.g., 510) that are authorized to execute/perform the electronic request once the electronic request is placed in the approved state; an approved state expiration timespan (e.g., 514) that denotes an amount of time after which the electronic request can no longer be executed and/or performed; and/or a maximum number (e.g., 516) of times that the electronic request can be executed.

In various instances, act 1606 can include initializing, by the device (e.g., via 118), an execution counter (e.g., 1404) for the electronic request. In various cases, such execution counter can be a dummy variable that is initially set to zero (e.g., indicating zero executions/performances conducted so far).

In various aspects, act 1608 can include receiving, by the device (e.g., via 112), an electronic execution command (e.g., one of 1402) that is associated with the electronic request. In various cases, the electronic execution command can be issued by an executing credential (e.g., the executing credential w) at a second time (e.g., indicated by the executing timestamp w). The computer-implemented method 1600 can then proceed to act 1702 of the computer-implemented method 1700.

In various embodiments, act 1702 can include determining, by the device (e.g., via 118), whether a difference between the second time (e.g., time/date at which the electronic execution command was issued) and the first time (e.g., time/date at which the electronic request entered the approved state) is greater than the approved state expiration timespan. If so, the computer-implemented method 1700 can proceed to act 1704. If not, the computer-implemented method 1700 can proceed to act 1802 of the computer-implemented method 1800.

In various aspects, act 1704 can include rejecting and/or discarding the electronic execution command. In other words, at act 1704, the electronic execution command can be considered as invalid for being untimely (e.g., for being issued after the approved state expiration timespan has elapsed).

In various instances, act 1706 can include proceeding back to act 1608 of the computer-implemented method 1600.

In various embodiments, act 1802 can include determining, by the device (e.g., via 118), whether the executing credential (e.g., the credential that issued the electronic execution command) is within the set of executor credentials specified by the MAV rule. If not, the computer-implemented method 1800 can proceed to act 1804. If so, the computer-implemented method 1800 can proceed to act 1902 of the computer-implemented method 1900.

In various aspects, act 1804 can include rejecting and/or discarding the electronic execution command. In other words, at act 1804, the electronic execution command can be considered as invalid for being issued by an unauthorized entity (e.g., for being issued by a credential that is not permitted to issue an execution command).

In various instances, act 1806 can include proceeding back to act 1608 of the computer-implemented method 1600.

In various embodiments, act 1902 can include determining, by the device (e.g., via 118), whether the executing credential (e.g., the credential that issued the electronic execution command) is the same as (e.g., matches) the requesting credential (e.g., the credential that issued the electronic request). If so, the computer-implemented method 1900 can proceed to act 1904. If not, the computer-implemented method 1900 can proceed to act 2002 of the computer-implemented method 2000.

In various aspects, act 1904 can include rejecting and/or discarding the electronic execution command. In other words, at act 1904, the electronic execution command can be considered as invalid for being a self-execution (e.g., for being issued by the same credential that issued the electronic request). Note that the electronic execution command can be rejected/discarded at act 1904 for being a self-execution, notwithstanding that the executing credential is listed in the set of executor credentials specified by the MAV rule, as verified at act 1802.

In various instances, act 1906 can include proceeding back to act 1608 of the computer-implemented method 1600.

In various embodiments, act 2002 can include determining, by the device (e.g., via 118), whether the executing credential (e.g., the credential that issued the electronic execution command) is within the set of valid approving credentials (e.g., the set of credentials that actually did issue valid electronic approvals for the electronic request, not necessarily the entire set of credentials that were authorized to issue electronic approvals for the electronic request). If so, the computer-implemented method 2000 can proceed to act 2004. If not, the computer-implemented method 2000 can proceed to act 2102 of the computer-implemented method 2100.

In various aspects, act 2004 can include rejecting and/or discarding the electronic execution command. In other words, at act 2004, the electronic execution command can be considered as invalid for being an alternative type of self-execution (e.g., for being issued by a same credential that actually issued a valid electronic approval for the electronic request). Note that the electronic execution command can be rejected/discarded at act 2004 for being an alternative type of self-execution, notwithstanding that the executing credential is listed in the set of executor credentials specified by the MAV rule, as verified at act 1802.

In various instances, act 2006 can include proceeding back to act 1608 of the computer-implemented method 1600.

In various embodiments, act 2102 can include accepting and/or deeming, by the device (e.g., via 118), the electronic execution command as valid, and incrementing, by the device (e.g., via 118), the execution counter by one.

In various aspects, act 2104 can include determining, by the device (e.g., via 118), whether the execution counter is now greater than the maximum number of times that the electronic request can be executed/performed, as specified by the MAV rule. If so, the computer-implemented method 2100 can proceed to act 2106. On the other hand, if not, the computer-implemented method 2100 can proceed to act 2108.

In various instances, act 2106 can include generating, by the device (e.g., via 118), a warning (e.g., 1406) that the electronic request has already been executed the maximum number of times.

In various cases, act 2108 can include executing/performing, by the device (e.g., via 118), the electronic request (e.g., thereby causing the data operation to be applied to the data object), and proceeding back to act 1608 of the computer-implemented method 1600.

Example Architecture for Multi-Admin Verification with Auto-Execution

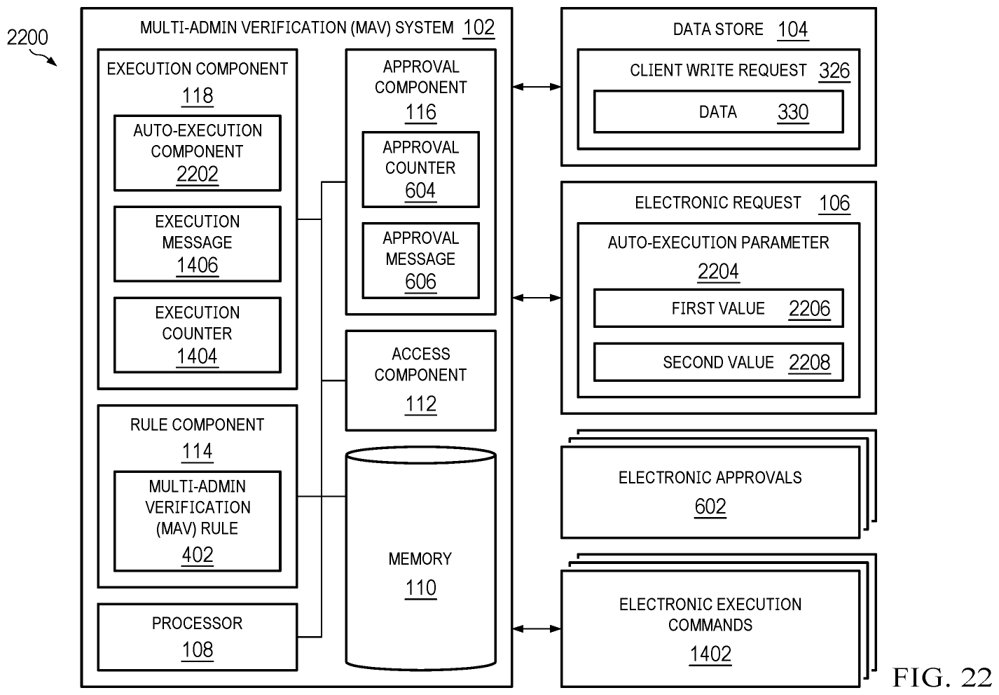

FIG. 22 illustrates a block diagram of an example, non-limiting system for automatically executing an electronic request once the electronic request has entered the approved state in accordance with one or more embodiments described herein. In various cases, as shown, the system 2200 can comprise the same components as the system 600 in FIG. 6 or the system 1400 in FIG. 14, and may further comprise an auto-execution component 2202 within the execution component 118.

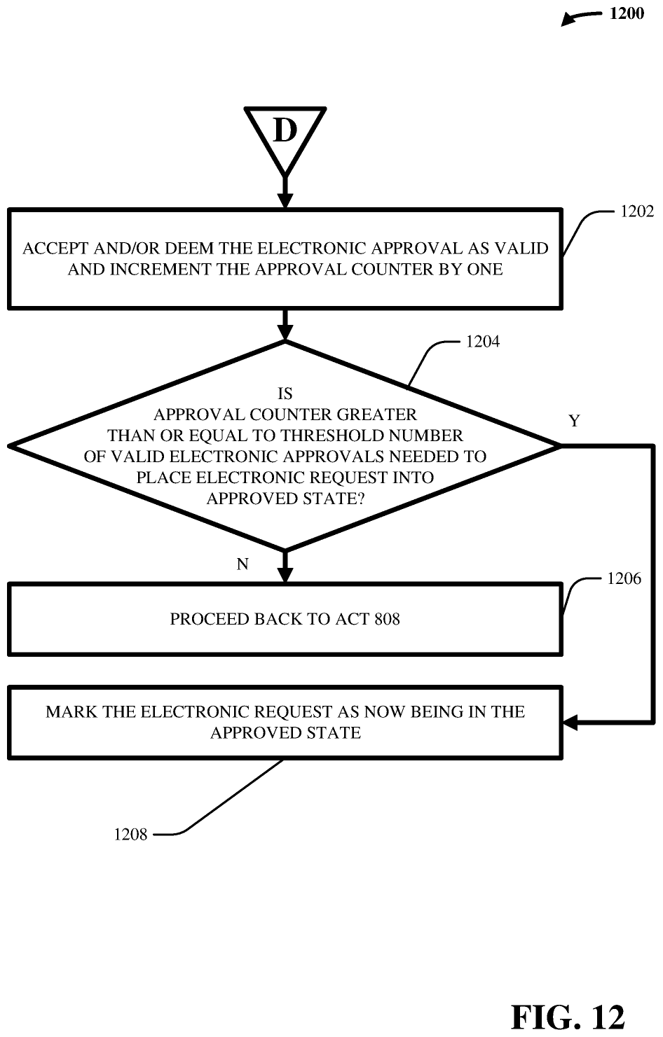

The auto-execution component 2202 may automatically execute the electronic request 106 when the electronic request 106 is designated for auto-execution and has entered an approved state. For example, once the electronic request 106 has been marked as being in the approved state (e.g., as described with respect to act 1208 in FIG. 12), the auto-execution component 2202 may automatically execute the electronic request 106. In some embodiments, the auto-execution component 2202 may automatically execute the electronic request 106 up to a selected number of times. This selected number of times may be selected or set by, for example, the MAV rule 402 (e.g., the number of execution denoted in Line 33 described above with respect to FIG. 13).

In one or more embodiments, the approval component 116 may recognize when the electronic request 106 is designated for auto-execution and may send a message or command (e.g., an approval message such as the approval message 604 in FIG. 6) to the auto-execution component 2202 once the electronic request 106 has entered the approved state. This message or command may cause the auto-execution component 2202 to initiate automatically executing the electronic request (e.g., automatically executing the data operation 304).

Alternatively, the execution component 118 may recognize when the electronic request 106 is designated for auto-execution and correspondingly, may monitor for a change in the state of the electronic request 106. For example, the execution component 118 may monitor the state of the electronic request 106 to determine when the electronic request 106 is marked as being in the approved state. Once the execution component 118 detects the approved state for the electronic request 106, the auto-execution component 2202 may initiate automatically executing the electronic request 106.

The electronic request 106 may be designated for auto-execution in various ways. For example, the electronic request 106 from FIG. 6 and FIG. 3 may include, identify, or otherwise indicate a value for an auto-execution parameter 2204. In one or more embodiments, the auto-execution parameter 2204 may be a tag, label, or other type of parameter associated with the electronic request 106. In some embodiments, the auto-execution parameter 2204 may be a parameter with a value that is included in the electronic data of the electronic request 106.

As one non-limiting example, the electronic request 106 may identify the value for the auto-execution parameter 2204 in association with the data operation 304. In one or more embodiments, the auto-execution parameter 2204 may have either a first value 2206 (e.g., TRUE, 1) that indicates that the data operation 304 is to be automatically executed once the electronic request 106 has entered the approved state or a second value 2208 (e.g., FALSE, 0) that indicates that the data operation 304 is not to be automatically executed upon the electronic request 106 entering the approved state.

In some embodiments, the electronic request 106 may be designated for auto-execution based on one or more settings and/or rules associated with multi-admin verification system 102. For example, in some cases, the multi-admin verification system 102 may flag the electronic request 106 for auto-execution upon matching the credential 306 associated with the electronic request 106 to a list of one or more credentials for which requests have been preapproved for auto-execution. In various cases, the multi-admin verification system 102 may add the first value 2206 for the auto-execution parameter 2204, designating the electronic request 106 for auto-execution, after determining that the credential 306 associated with the electronic request 106 matches one on a list of one or more credentials for which requests have been preapproved for auto-execution.

In other embodiments, the auto-execution component 2202 may include one or more processes such as, but not limited to, one or more artificial intelligence-based (AI-based) processes that are able to determine if and when an electronic request 106 that has been received by the MAV system 102 should be designated for auto-execution. For example, an AI-based component within the auto-execution component 2202 may analyze the contents (e.g., data object 302, data operation 304, credential 306, and/or timestamp 308, etc.) of or associated with the electronic request 106 and determine whether the electronic request 106 should be designated for auto-execution.

The electronic request 106 may be designated for auto-execution at various points in time including, for example, prior to the electronic request 106 being received for processing by the MAV system 102 or as part of the approval process for which each electronic approval of the set of electronic approvals 602 is generated. For example, the electronic request 106 may be received from a computing device having the auto-execution parameter 2204 set with the first value 2206 designating the electronic request 106 for auto-execution. In one non-limiting example, once the electronic request 106 has been created, the originator of the electronic request 106 may receive a notification or alert asking whether the electronic request 106 should be designated for auto-execution. The MAV system 102 may then designate the electronic request for auto-execution in response to receiving input issued by the requestor credential of the originator of the electronic request confirming that the electronic request is to be designated for auto-execution.

In other examples, the electronic request 106 may be designated for auto-execution by one of the approvers (e.g., a user having an approver credential included in the set of approver credentials 506 in FIG. 5, or an approver process operating with an approver credential included in the set of approver credentials 506). In some cases, the electronic request 106 may be designated for auto-execution by the final approver in the approval process. The final approver may be the approver (e.g., user, approver process) that provides the final electronic approval that increments the approval counter 604 to the threshold number of valid electronic approvals needed to place the electronic request 106 into the approved state.

The auto-execution component 2202, in some cases, may include one or more processes such as, but not limited to, one or more artificial intelligence-based (AI-based) processes that designate the electronic request 106 for auto-execution in response to detecting that a selected electronic approval or number of electronic approvals have been received from one or more approver credentials (e.g., one or more of the set of approver credentials 506) that are identified on a list of one or more approver credentials associated with pre-approval for auto-execution.

In this manner, the electronic request 106 may be designated for auto-execution in different ways and at different times. Conversely, in one or more embodiments, an electronic request 106 that has been designated for auto-execution may be undesignated for auto-execution by one of the approvers in the approval process. In other words, one of the approvers may disable the auto-execution feature associated with the electronic request 106. For example, without limitation, the final approver may change the value of the auto-execution parameter 2204 from the first value 2206 to the second value 2208 to remove its auto-execution designation. In some cases, an approver that provides electronic approval prior to the final approver may remove the auto-execution designation.

The auto-execution component 2022 may, in some cases, include one or more processes such as, but not limited to, one or more artificial intelligence-based (AI-based) processes that determine when to remove the auto-execution designation or otherwise disable auto-execution for an electronic request 106.

In one or more embodiments, the execution component 118 may be capable of blocking or otherwise preventing auto-execution despite the designation of the electronic request 106. For example, in some cases, for security, compliance, and/or risk mitigation purposes, the execution component 118 may set a tag, flag, or label that trumps any designation of the electronic request and disables auto-execution such that the electronic request 106 is not automatically executed when the electronic request 106 enters the approved state, regardless of its designation. Such a feature may serve as a failsafe in certain instances.

Using auto-execution, the system 2200 may reduce the overall time and computing resources associated with executing or performing the electronic request 106. Using auto-execution, the MAV system 102 does not need to wait for an entity (e.g., human user or process with a valid or authorized executing credential) to provide their executing credential and generate an execution command and does not need to determine whether the executing credential is valid or authorized.

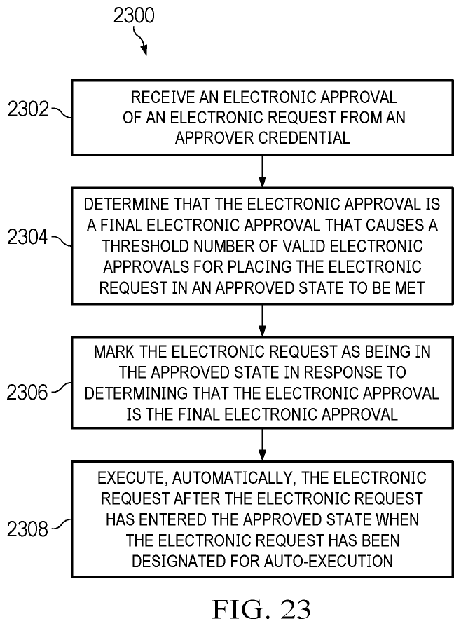

FIG. 23 illustrates a flow diagram of an example, non-limiting computer-implemented method for facilitating automatically executing an electronic request in accordance with one or more embodiments described herein. The method 2300 illustrated in FIG. 23 may be implemented using one or more components of the MAV system 102 described with respect to FIG. 22.

In various instances, act 2302 can include receiving an electronic approval of an electronic request from an approver credential. The electronic approval of the electronic request (e.g., electronic request 106) may be associated with an approver credential such as one of approver credentials 506.

In various instances, act 2304 can include determining that the electronic approval is a final electronic approval that causes a threshold number of valid electronic approvals for placing the electronic request in an approved state to be met. In act 2304, when the approval counter (e.g., approval counter 604) reaches the threshold number of valid electronic approvals needed to place the electronic request into the approved state, the electronic approval is determined to be the final electronic approval and the approver credential that issued the final electronic approval is the final approver credential associated with a final approver.

In various instances, act 2306 can include marking the electronic request as being in the approved state in response to determining that the electronic approval is the final electronic approval. Act 2306 may be implemented in a manner similar to act 1208 described with respect to FIG. 12. Marking the electronic request as being in the approved state may include tagging, labeling, flagging, or otherwise indicating the electronic request is in the approved state. In some cases, marking the electronic request as being in the approved state may include adding an identifier or index associated with the electronic request to a list being managed by the MAV system 102, the list identifying those electronic requests that have entered the approved state. In other cases, marking the electronic request as being in the approved state may include changing a designation associated with the electronic request in a list or database being managed by the MAV system 102.

In various instances, act 2308 can include executing, automatically, the electronic request after the electronic request has entered the approved state when the electronic request has been designated for auto-execution. For example, the electronic request may be associated with an auto-execution parameter (e.g., auto-execution parameter 2204) that has the first value 2206 indicating that the electronic request is designated for auto-execution. Act 2306 may be implemented by, for example, the auto-execution component 2202 of the execution component 118 of the MAV system 102 in FIG. 22. In one or more embodiments, act 2308 may include executing, automatically, the electronic request a number of times after the electronic request has entered the approved state. This number of times may be defined by a repeat parameter associated with the electronic request and may include more than one time such that the electronic request is executed multiple times.

In some cases, the MAV system 102 may receive input entered with the approver credential of the final approver that provides the final electronic approval changing the designation of the electronic request to designate the electronic request for auto-execution. In some cases, the MAV system 102 may receive input entered with a valid approver credential associated with a valid electronic approval that is provided before the final electronic approval. This input may cause the MAV system 102 to change the designation of the electronic request to designate it for auto-execution prior to the final electronic approval being issued by the final approver credential.

Automatically executing the electronic request includes executing or performing the data operation associated with the electronic request without requiring a user to log in to the MAV system 102 and provide executing commands. Thus, the execution system 118 of the MAV system 102 does not need to evaluate the executing credentials issuing any executing commands, thereby reducing the overall time and computing resources associated with executing the electronic request.

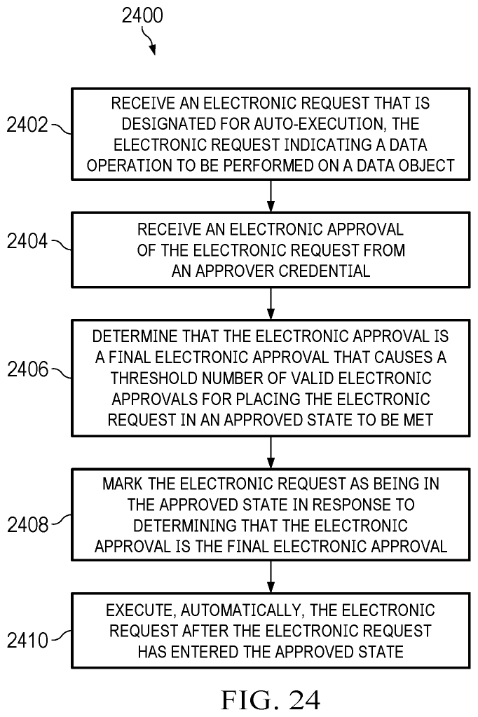

FIG. 24 illustrates a flow diagram of an example, non-limiting computer-implemented method for facilitating auto-execution of an electronic request in accordance with one or more embodiments described herein. The method 2400 illustrated in FIG. 24 may be implemented using one or more components of the MAV system 102 described with respect to FIG. 22.

In various instances, act 2402 can include receiving an electronic request that is designated for auto-execution, the electronic request indicating a data operation to be performed on a data object. The electronic request may, for example, have an auto-execution parameter with a value that designates the electronic request for auto-execution. In some cases, the electronic request has an identifier that is included in a list of identifiers for electronic requests designated for auto-execution. For example, when an electronic request is received, execution component 118 may determine whether the electronic data contained within and/or associated with the electronic request indicates that the electronic request should be designated for auto-execution. In such instances, the identifier of the electronic request may be added to a list of identifiers for electronic requests that have been designated for auto-execution. The electronic request may be designated for auto-execution in other ways.

In various instances, act 2404 can include receiving an electronic approval of the electronic request from an approver credential. The approver credential may be one of a set of approver credentials 506 authorized for approving the electronic request.

In various instances, act 2406 can include determining that the electronic approval is a final electronic approval that causes a threshold number of valid electronic approvals for placing the electronic request in an approved state to be met. For example, if the threshold number of valid electronic approvals for placing the electronic request in an approved state is 4 approvals, then the final electronic approval may be the fourth valid electronic approval that is received.

In various instances, act 2408 can include marking the electronic request as being in the approved state in response to determining that the electronic approval is the final electronic approval. Act 2408 may be implemented in a manner similar to act 2308 described above with respect to FIG. 23.

In various instances, act 2410 can include automatically executing the electronic request after the electronic request has entered the approved state. In one or more embodiments, the execution component (e.g., execution component 118) of the MAV system 102 receives a message from the approval component (e.g., approval component 116) of the MAV system 102 indicating that the electronic request has entered the approved state. The execution component may determine that the electronic request is designated for auto-execution by, for example, detecting that the electronic request has an auto-execution parameter with a value indicating designation for auto-execution, checking an identifier of the electronic request against a list of identifiers for electronic requests that have been designated for auto-execution, or confirming the auto-execution designation in some other manner. In some embodiments, act 2410 may include determining that the electronic request is designated for auto-execution before automatically executing the electronic request (e.g., via detecting the designation based on an auto-execution parameter associated with the electronic request).

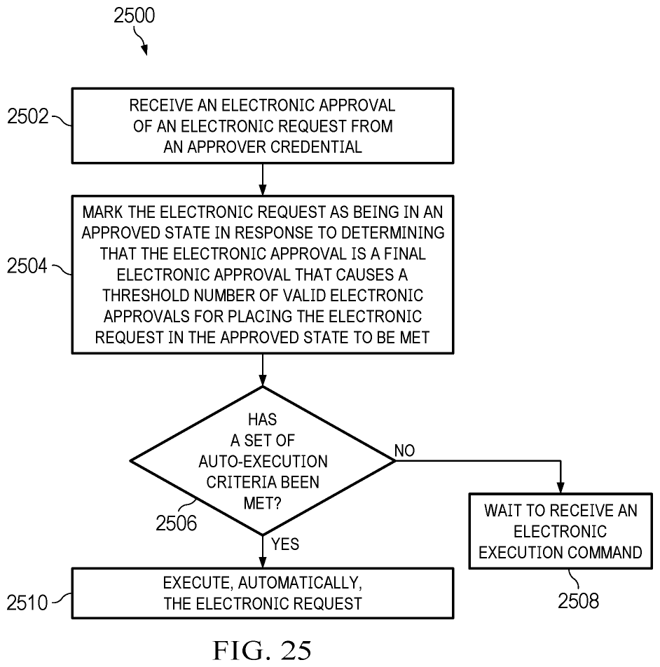

FIG. 25 illustrates a flow diagram of an example, non-limiting computer-implemented method for facilitating auto-execution of an electronic request in accordance with one or more embodiments described herein. The method 2500 illustrated in FIG. 25 may be implemented using one or more components of the MAV system 102 described with respect to FIG. 22.

In various instances, act 2502 can include receiving an electronic approval of an electronic request from an approver credential.

In various instances, act 2504 can include marking the electronic request as being in an approved state in response to determining that the electronic approval is a final electronic approval that causes a threshold number of valid electronic approvals for placing the electronic request in the approved state to be met.

In various instances, act 2506 can include determining whether a set of auto-execution criteria has been met when the electronic request is in the approved state. The set of auto-execution criteria may include, for example, without limitation, at least one of the approver credential being on a list of preapproved approver credentials associated with auto-execution, a data operation indicated by the electronic request being on a list of preapproved data operations associated with auto-execution, or another criterion.

If the set of auto-execution criteria has not been met, the method 2500 proceeds to act 2508, which can include waiting to receive an electronic execution command (e.g., the electronic execution command received in act 1608 in FIG. 16 described above). If, however, the set of auto-execution criteria has been met, the method 2500 proceeds to act 2510, which can include executing, automatically, the electronic request.

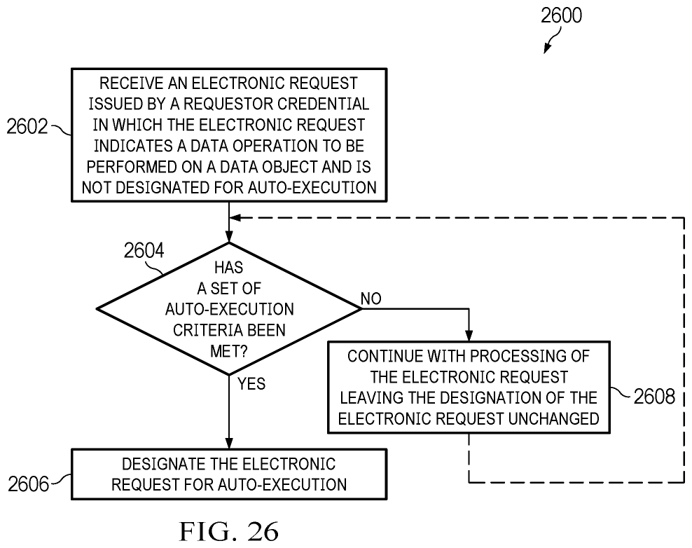

FIG. 26 illustrates a flow diagram of an example, non-limiting computer-implemented method for facilitating auto-execution of an electronic request in accordance with one or more embodiments described herein. The method 2600 illustrated in FIG. 26 may be implemented using one or more components of the MAV system 102 described with respect to FIG. 22.

In various instances, act 2602 can include receiving an electronic request issued by a requestor credential in which the electronic request indicates a data operation to be performed on a data object and is not designated for auto-execution.

Act 2604 can include determining whether a set of auto-execution criteria is met. If the set of auto-execution criteria is met, the method 2600 proceeds to act 2606, which can include designating the electronic request for auto-execution. If, however, the set of auto-execution criteria is not met, the method 2600 proceeds to act 2608, which can include continuing with processing of the electronic request leaving the designation of the electronic request unchanged. In one or more embodiments, meeting the set of auto-execution criteria includes meeting, one, two, three, four, five, six, seven, eight, nine, ten, or some other selected number of criteria that have been selected as the threshold for auto-execution designation.

The auto-execution criteria may take various forms. For example, act 2604 may include determining whether the requestor credential that issued the electronic request matches a credential on a list of preapproved credentials associated with auto-execution. The list of preapproved credentials may be those credentials for which requests issued by those credentials can be auto-executed. Thus, the set of auto-execution criteria may include the requestor credential of the electronic request matching a credential on a list of preapproved credentials associated with auto-execution. In some cases, the requestor credential may be one of a group of requestor credentials that have been flagged as being authorized for auto-execution. For example, this group of requestor credentials may be include requestor credentials that have been vetted, successfully passed through one or more layers of security, or authorized in some other manner such that any electronic requests issued by these requestor credentials are flagged to be automatically designated for auto-execution.

In various examples, act 2604 may include determining whether at least one approver credential that issued a valid electronic approval of the electronic request matches a credential on a list of preapproved approver credentials associated with auto-execution. The list of preapproved approver credentials may be those approver credentials for which electronic approvals issued by those approver credentials can authorize auto-execution. Thus, the set of auto-execution criteria may include at least one (or some selected number of) approver credentials that issued a valid electronic approval of the electronic request matching a credential on a list of preapproved approver credentials associated with auto-execution.

In various examples, act 2604 may include determining whether the data operation associated with the electronic request is on a list of preapproved data operations associated with auto-execution. The list of preapproved data operations may be those data operations for which for which auto-execution is authorized without requiring separate execution commands. For example, certain read operations may be preapproved for auto-execution, while certain write operations may not be preapproved for auto-execution. Thus, the set of auto-execution criteria may include the data operation indicated by the electronic request being on a list of preapproved data operations associated with auto-execution. In some cases, the data operation may be a type of data operation that is part of a group of types of data operations flagged for auto-execution.

In various examples, act 2604 may include determining whether the data object associated with the electronic request is on a list of preapproved data objects associated with auto-execution. The list of preapproved data objects may be those data objects for which for which auto-execution of data operations associated with those data objects is authorized without requiring separate execution commands. For example, certain data objects may be considered low-risk data objects such that any data operation to be implemented on such a data object is preapproved for auto-execution after valid electronic approvals for the data operation have been obtained. Thus, the set of auto-execution criteria may include the data object indicated by the electronic request being on a list of preapproved data objects associated with auto-execution. In some cases, the data object may be a type of data object that is a part of a group of types of data objects flagged for auto-execution.

Act 2604 may be performed at various times within the processing of the electronic request. For example, act 2604 may be performed upon receipt of an electronic request but prior to any electronic approval is requested or provided by an approver credential. In some cases, act 2604 may be performed after a next-to-final electronic approval of the electronic request has been received. In other cases, act 2604 may be performed after the final electronic approval of the electronic request has been received. In still other cases, act 2604 may be performed repeatedly during the processing of electronic request as a background process so that the electronic request may be designated for auto-execution at any point before or during the approval process up until after the electronic request has been marked as being in the approved state. For example, the method 2600 may return to act 2604 as part of or after act 2608.

With reference again to act 2606, the electronic request may be designated for auto-execution in different ways. In one or more embodiments, a value for an auto-execution parameter for the electronic request may be changed from a first value (e.g., first value 2206) to a second value (e.g., second value 2208) to designate the electronic request for auto-execution. In other embodiments, an identifier for the electronic request may be added to a list of electronic requests approved for auto-execution.

### Additional Implementation Considerations Generally Applicable to FIGS. 1-26

Although the herein disclosure has so far described various embodiments that treat the data object 302 as an electronic file, document, image, video recording, audio recording, and/or executable script, these are mere non-limiting examples for ease of explanation. In various other embodiments, and as described further below, the data object 302 can be the MAV rule 402 itself. In particular, as described herein, the MAV rule 402 can be considered as a stringent restriction/regulation that is very difficult for a spoofer and/or rogue entity to bypass. Accordingly, the spoofer and/or rogue entity might attempt to edit, change, and/or otherwise manipulate the contents of the MAV rule 402, so as to make the MAV rule 402 easier to satisfy. For example, the spoofer and/or rogue entity might try to reduce the threshold number of approvals 508, and/or might try to insert spoofed credentials into the set of approver credentials 506 and/or into the set of executor credentials 510. To prevent such malicious editing of the MAV rule 402, the MAV rule 402 can protect itself. In other words, the MAV rule 402 can itself be listed in the set of protected data objects 502 (e.g., the MAV rule 402 can be self-referential). In still other words, if any electronic request attempts to perform any of the set of protected data operations 504 on the MAV rule 402 itself, the execution/performance of such electronic request can be prevented/prohibited, unless such electronic request satisfies the requirements/prohibitions of the MAV rule 402 (e.g., requirement for a threshold number of approvals, requirement for approvals to be issued from authorized credentials, prohibition on self-approvals, prohibition on untimely approvals, requirement for execution commands to be issued from authorized credentials, prohibition on self-executions, prohibition on untimely execution commands).

In still other cases, the data object 302 can be any other suitable MAV rule, even if different from the MAV rule 402. In other words, the MAV rule 402 can protect not only itself but also one or more other and/or different MAV rules, as desired.

In various embodiments, any suitable machine learning algorithms and/or artificial intelligence techniques can be implemented to help improve various functionalities of the MAV system 102. For example, in some cases, machine learning algorithms and/or artificial intelligence techniques can be implemented to automatically generate the MAV rule 402 and/or to automatically populate the set of protected data objects 502, the set of protected data operations 504, the set of approver credentials 506, the threshold number of approvals 508, the set of executor credentials 510, the request expiration timespan 512, the approved state expiration timespan 514, and/or the permissible number of executions 516. As another example, in some cases, machine learning algorithms and/or artificial intelligence techniques can be implemented to predict whether or not a sufficient number of electronic approvals are likely to be received for the electronic request 106.

In any case, various embodiments described herein constitute a computerized tool that can implement multi-admin verification to improve security of data stores. As explained herein, RBAC and/or MFA techniques can leave significant security gaps that threaten the integrity of a data store, and the computerized tool described herein can implement MAV rules to shore up such significant security gaps. Accordingly, such computerized tool is certainly a useful and practical application of computers.

Although the herein disclosure mainly describes various embodiments of the MAV rule 402 as specifying various credentials (e.g., the set of approver credentials 506, the set of executor credentials 510), this is a mere non-limiting example for ease of explanation. In various embodiments, rather than specifying credentials (e.g., rather than specifying usernames and/or passwords) of entities that are authorized to approve and/or execute the electronic request 106, the MAV rule 402 can specify any other suitable identifiers of such entities as desired. As a non-limiting example, suppose that an entity Q is authorized to approve the electronic request 106. In some cases, the MAV rule 402 can specify the credentials that correspond to the entity Q (e.g., can specify, within the set of approver credentials 506, the username and/or password of the entity Q). In other cases, however, the MAV rule 402 can refrain from specifying the credentials of the entity Q and can instead specify any other suitable identifier of the entity Q (e.g., can specify a name of the entity Q, an account number of the entity Q, and/or any other suitable alphanumeric identifier that serves to distinguish the entity Q from other entities). Therefore, and as those having ordinary skill in the art will appreciate, the set of approver credentials 506 can, in various instances, be replaced with and/or otherwise considered more generally as a set of approver identifiers (e.g., a set of identifiers of entities that are permitted to approve the electronic request 106), and the set of executor credentials 510 can likewise be replaced with and/or otherwise considered more generally as a set of executor identifiers (e.g., a set of identifiers of entities that are permitted to execute the electronic request 106).

Although the herein disclosure mainly describes various embodiments as enforcing multi-admin verification rules with respect to data objects maintained within a data store, this is a mere non-limiting example for ease of explanation and/or illustration. In various other embodiments, the herein-described teachings can be applied and/or extrapolated to any suitable resource and/or element within the data store that can be configurable, editable, changeable, and/or otherwise manipulable. In other words, an MAV rule can be implemented to protect any changeable resource and/or element of the data store as desired; an MAV rule can be not limited to protecting only data objects. As some non-limiting examples, such changeable resources and/or elements can include containers (e.g., aggregates, volumes), snapshots, data mirrors, and/or user accounts.

In various instances, machine learning algorithms and/or models can be implemented in any suitable way to facilitate any suitable aspects described herein (e.g., in some cases, the MAV system 102 can utilize machine learning when performing its functionalities). To facilitate some of the above-described machine learning aspects of various embodiments, consider the following discussion of artificial intelligence (AI). Various embodiments described herein can employ artificial intelligence to facilitate automating one or more features and/or functionalities. The components can employ various AI-based schemes for carrying out various embodiments/examples disclosed herein. In order to provide for or aid in the numerous determinations (e.g., determine, ascertain, infer, calculate, predict, prognose, estimate, derive, forecast, detect, compute) described herein, components described herein can examine the entirety or a subset of the data to which it is granted access and can provide for reasoning about or determine states of the system and/or environment from a set of observations as captured via events and/or data. Determinations can be employed to identify a specific context or action, or can generate a probability distribution over states, for example. The determinations can be probabilistic; that is, the computation of a probability distribution over states of interest based on a consideration of data and events. Determinations can also refer to techniques employed for composing higher-level events from a set of events and/or data.

Such determinations can result in the construction of new events or actions from a set of observed events and/or stored event data, whether or not the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, and so on)) schemes and/or systems (e.g., support vector machines, neural networks, expert systems, Bayesian belief networks, fuzzy logic, data fusion engines, and so on) in connection with performing automatic and/or determined action in connection with the claimed subject matter. Thus, classification schemes and/or systems can be used to automatically learn and perform a number of functions, actions, and/or determinations.

A classifier can map an input attribute vector, z=(z₁, z₂, z₃, z₄, zₙ), to a confidence that the input belongs to a class, as by f(z)=confidence(class). Such classification can employ a probabilistic and/or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and/or probabilistic classification models providing different patterns of independence, any of which can be employed. Classification as used herein also is inclusive of statistical regression that is utilized to develop models of priority.

Those having ordinary skill in the art will appreciate that the herein disclosure describes non-limiting examples of various embodiments. For ease of description and/or explanation, various portions of the herein disclosure utilize the term “each” when discussing various embodiments. Those having ordinary skill in the art will appreciate that such usages of the term “each” are non-limiting examples. In other words, when the herein disclosure provides a description that is applied to “each” of some particular object and/or component, it should be understood that this is a non-limiting example of various embodiments, and it should be further understood that, in various other embodiments, it can be the case that such description applies to fewer than “each” of that particular object and/or component.

### Example Computing Environments

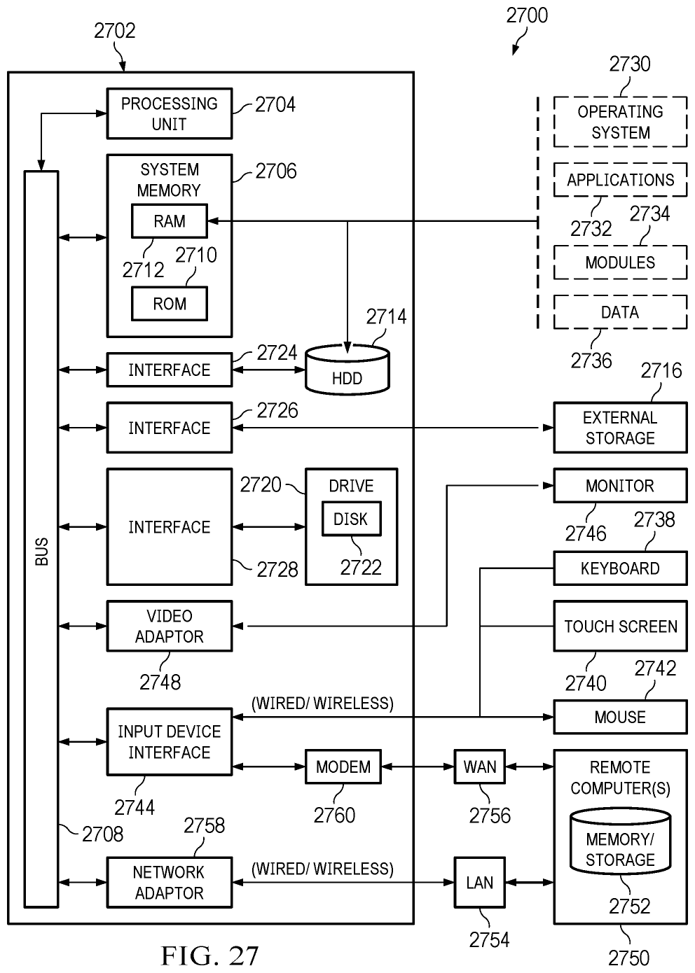

In order to provide additional context for the various embodiments described herein, FIG. 27 and the following discussion are intended to provide a brief, general description of a suitable computing environment 2700 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multi-processor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 27, the example environment 2700 for implementing various embodiments of the aspects described herein includes a computer 2702, the computer 2702 including a processing unit 2704, a system memory 2706 and a system bus 2708. The system bus 2708 couples together system components including, but not limited to, the system memory 2706 to the processing unit 2704. The processing unit 2704 can be any of various commercially available processors. Dual microprocessors and other multi-processor architectures can also be employed as the processing unit 2704.

The system bus 2708 can be any of several types of bus structure that can further interconnect to a memory bus (with or without a memory controller), a peripheral bus, and a local bus using any of a variety of commercially available bus architectures. The system memory 2706 includes ROM 2710 and RAM 2712. A basic input/output system (BIOS) can be stored in a non-volatile memory such as ROM, erasable programmable read only memory (EPROM), EEPROM, which BIOS contains the basic routines that help to transfer information between elements within the computer 2702, such as during startup. The RAM 2712 can also include a high-speed RAM such as static RAM for caching data.

The computer 2702 further includes an internal hard disk drive (HDD) 2714 (e.g., EIDE, SATA), one or more external storage devices 2716 (e.g., a magnetic floppy disk drive (FDD) 2716, a memory stick or flash drive reader, a memory card reader, etc.) and a drive 2720, e.g., such as a solid state drive, an optical disk drive, which can read or write from a disk 2722, such as a CD-ROM disc, a DVD, a BD, etc. Alternatively, where a solid state drive is involved, disk 2722 would not be included, unless separate. While the internal HDD 2714 is illustrated as located within the computer 2702, the internal HDD 2714 can also be configured for external use in a suitable chassis (not shown). Additionally, while not shown in environment 2700, a solid state drive (SSD) could be used in addition to, or in place of, an HDD 2714. The HDD 2714, external storage device(s) 2716 and drive 2720 can be connected to the system bus 2708 by an HDD interface 2724, an external storage interface 2726 and a drive interface 2728, respectively. The interface 2724 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 2702, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 2712, including an operating system 2730, one or more application programs 2732, other program modules 2734 and program data 2736. All or portions of the operating system, applications, modules, and/or data can also be cached in the RAM 2712. The systems and methods described herein can be implemented utilizing various commercially available operating systems or combinations of operating systems.

Computer 2702 can optionally comprise emulation technologies. For example, a hypervisor (not shown) or other intermediary can emulate a hardware environment for operating system 2730, and the emulated hardware can optionally be different from the hardware illustrated in FIG. 27. In such an embodiment, operating system 2730 can comprise one virtual machine (VM) of multiple VMs hosted at computer 2702. Furthermore, operating system 2730 can provide runtime environments, such as the Java runtime environment or the .NET framework, for applications 2732. Runtime environments are consistent execution environments that allow applications 2732 to run on any operating system that includes the runtime environment. Similarly, operating system 2730 can support containers, and applications 2732 can be in the form of containers, which are lightweight, standalone, executable packages of software that include, e.g., code, runtime, system tools, system libraries and settings for an application.

Further, computer 2702 can be enable with a security module, such as a trusted processing module (TPM). For instance with a TPM, boot components hash next in time boot components, and wait for a match of results to secured values, before loading a next boot component. This process can take place at any layer in the code execution stack of computer 2702, e.g., applied at the application execution level or at the operating system (OS) kernel level, thereby enabling security at any level of code execution.

A user can enter commands and information into the computer 2702 through one or more wired/wireless input devices, e.g., a keyboard 2738, a touch screen 2740, and a pointing device, such as a mouse 2742. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 2704 through an input device interface 2744 that can be coupled to the system bus 2708, but can be connected by other interfaces, such as a parallel port, an IEEE 1394 serial port, a game port, a USB port, an IR interface, a BLUETOOTH® interface, etc.

A monitor 2746 or other type of display device can be also connected to the system bus 2708 via an interface, such as a video adapter 2748. In addition to the monitor 2746, a computer typically includes other peripheral output devices (not shown), such as speakers, printers, etc.

The computer 2702 can operate in a networked environment using logical connections via wired and/or wireless communications to one or more remote computers, such as a remote computer(s) 2750. The remote computer(s) 2750 can be a workstation, a server computer, a router, a personal computer, portable computer, microprocessor-based entertainment appliance, a peer device or other common network node, and typically includes many or all of the elements described relative to the computer 2702, although, for purposes of brevity, only a memory/storage device 2752 is illustrated. The logical connections depicted include wired/wireless connectivity to a local area network (LAN) 2754 and/or larger networks, e.g., a wide area network (WAN) 2756. Such LAN and WAN networking environments are commonplace in offices and companies, and facilitate enterprise-wide computer networks, such as intranets, all of which can connect to a global communications network, e.g., the Internet.

When used in a LAN networking environment, the computer 2702 can be connected to the local network 2754 through a wired and/or wireless communication network interface or adapter 2758. The adapter 2758 can facilitate wired or wireless communication to the LAN 2754, which can also include a wireless access point (AP) disposed thereon for communicating with the adapter 2758 in a wireless mode.

When used in a WAN networking environment, the computer 2702 can include a modem 2760 or can be connected to a communications server on the WAN 2756 via other means for establishing communications over the WAN 2756, such as by way of the Internet. The modem 2760, which can be internal or external and a wired or wireless device, can be connected to the system bus 2708 via the input device interface 2744. In a networked environment, program modules depicted relative to the computer 2702 or portions thereof, can be stored in the remote memory/storage device 2752. It will be appreciated that the network connections shown are example and other means of establishing a communications link between the computers can be used.

When used in either a LAN or WAN networking environment, the computer 2702 can access cloud storage systems or other network-based storage systems in addition to, or in place of, external storage devices 2716 as described above, such as but not limited to a network virtual machine providing one or more aspects of storage or processing of information. Generally, a connection between the computer 2702 and a cloud storage system can be established over a LAN 2754 or WAN 2756 e.g., by the adapter 2758 or modem 2760, respectively. Upon connecting the computer 2702 to an associated cloud storage system, the external storage interface 2726 can, with the aid of the adapter 2758 and/or modem 2760, manage storage provided by the cloud storage system as it would other types of external storage. For instance, the external storage interface 2726 can be configured to provide access to cloud storage sources as if those sources were physically connected to the computer 2702.

The computer 2702 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

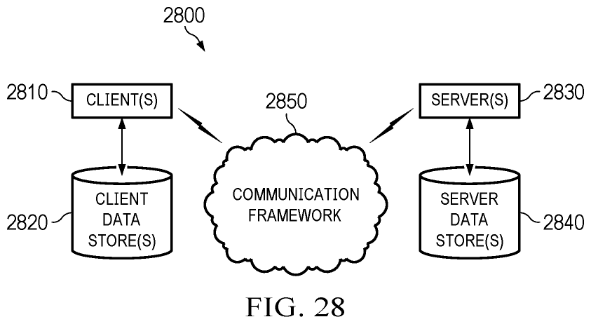

FIG. 28 is a schematic block diagram of a sample computing environment 2800 with which the disclosed subject matter can interact. The sample computing environment 2800 includes one or more client(s) 2810. The client(s) 2810 can be hardware and/or software (e.g., threads, processes, computing devices). The sample computing environment 2800 also includes one or more server(s) 2830. The server(s) 2830 can also be hardware and/or software (e.g., threads, processes, computing devices). The servers 2830 can house threads to perform transformations by employing one or more embodiments as described herein, for example. One possible communication between a client 2810 and a server 2830 can be in the form of a data packet adapted to be transmitted between two or more computer processes. The sample computing environment 2800 includes a communication framework 2850 that can be employed to facilitate communications between the client(s) 2810 and the server(s) 2830. The client(s) 2810 are operably connected to one or more client data store(s) 2820 that can be employed to store information local to the client(s) 2810. Similarly, the server(s) 2830 are operably connected to one or more server data store(s) 2840 that can be employed to store information local to the servers 2830.

Various embodiments described herein may be a system, a method, an apparatus and/or a computer program product at any possible technical detail level of integration. The computer program product can include a computer readable storage medium (or media) having computer readable program instructions thereon for causing a processor to carry out aspects of various embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adaptor card or network interface in each computing/processing device receives computer readable program instructions from the network and forwards the computer readable program instructions for storage in a computer readable storage medium within the respective computing/processing device. Computer readable program instructions for carrying out operations of various embodiments described herein can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of various embodiments described herein.

Aspects of various embodiments are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments described herein. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, data structures, etc. that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for automatically executing an electronic request, the method comprising:
receiving an electronic approval of the electronic request from an approver credential;
determining that the electronic approval is a final electronic approval that causes a threshold number of valid electronic approvals for placing the electronic request in an approved state to be met;
marking the electronic request as being in the approved state in response to determining that the electronic approval is the final electronic approval; and
executing, automatically, the electronic request after the electronic request has entered the approved state when the electronic request has been designated for auto-execution.

2. The method of claim 1, further comprising:
receiving the electronic request as being designated for auto-execution, the electronic request indicating a data operation to be performed on a data object.

3. The method of claim 1, further comprising:
receiving the electronic request having an auto-execution parameter with a value that designates the electronic request for auto-execution.

4. The method of claim 1, further comprising:
changing a designation of the electronic request to designate the electronic request for auto-execution based on input entered with the approver credential prior to the approver credential issuing the final electronic approval.

5. The method of claim 1, further comprising:
changing, prior to the approver credential issuing the final electronic approval, a value of an auto-execution parameter associated with the electronic request from a first value to a second value to designate the electronic request for auto-execution based on input entered with the approver credential.

6. The method of claim 1, further comprising:
changing a designation of the electronic request to designate the electronic request for auto-execution based on input entered with a valid approver credential prior to the approver credential issuing the final electronic approval.

7. The method of claim 1, further comprising:
changing, prior to the approver credential issuing the final electronic approval, a value of an auto-execution parameter associated with the electronic request from a first value to a second value to designate the electronic request for auto-execution based on input entered with a valid approver credential that is different from the approver credential.

8. The method of claim 1, wherein executing, automatically, the electronic request comprises:
executing, automatically, the electronic request a number of times after the electronic request has entered the approved state, wherein the number of times is defined by a repeat parameter associated with the electronic request and includes more than one time.

9. The method of claim 1, further comprising:
receiving the electronic request issued by a requestor credential;
generating a notification asking whether the electronic request is to be designated for auto-execution; and
designating the electronic request for auto-execution in response to receiving input issued by the requestor credential confirming that the electronic request is to be designated for auto-execution.

10. The method of claim 1, further comprising:
designating the electronic request for auto-execution in response to determining that at least one approver credential that issued a valid electronic approval of the electronic request matches a credential on a list of preapproved approver credentials associated with auto-execution.

11. The method of claim 1, further comprising:
designating the electronic request for auto-execution in response to determining that a requestor credential that issued the electronic request matches a credential on a list of preapproved credentials associated with auto-execution.

12. The method of claim 1, further comprising:
designating the electronic request for auto-execution in response to determining that a data operation associated with the electronic request is on a list of preapproved data operations associated with auto-execution.

13. The method of claim 1, further comprising:
designating the electronic request for auto-execution in response to determining that a data object associated with the electronic request is on a list of preapproved data objects associated with auto-execution.

14. A computing device comprising:
a memory containing machine readable medium comprising machine executable code having stored thereon instructions; and
a processor coupled to the memory, the processor configured to execute the machine executable code to cause the processor to:
receive an electronic request that is designated for auto-execution, the electronic request indicating a data operation to be performed on a data object;
receive an electronic approval of the electronic request from an approver credential;
determine that the electronic approval is a final electronic approval that causes a threshold number of valid electronic approvals for placing the electronic request in an approved state to be met;
mark the electronic request as being in the approved state in response to determining that the electronic approval is the final electronic approval; and
automatically execute the electronic request after the electronic request has entered the approved state.

15. The computing device of claim 14, wherein the electronic request has an auto-execution parameter with a value that designates the electronic request for auto-execution.

16. The computing device of claim 14, wherein the electronic request has an identifier that is included in a list of identifiers for electronic requests designated for auto-execution.

17. The computing device of claim 14, wherein the processor is configured to execute the machine executable code to cause the processor to automatically execute the electronic request a number of times after the electronic request has entered the approved state, wherein the number of times is defined by a repeat parameter associated with the electronic request and includes more than one time.

18. The computing device of claim 14, wherein the processor is configured to execute the machine executable code to cause the processor to send a command to initiate automatic execution of the electronic request after the electronic request enters the approved state.

19. A non-transitory machine-readable medium having stored thereon instructions for automatically executing an electronic request, the non-transitory machine-readable medium comprising machine executable code which, when executed by at least one machine, causes the at least one machine to:
receive an electronic approval of the electronic request from an approver credential;
mark the electronic request as being in an approved state in response to determining that the electronic approval is a final electronic approval that causes a threshold number of valid electronic approvals for placing the electronic request in the approved state to be met;
determine that a set of auto-execution criteria have been met when the electronic request is in the approved state; and
execute, automatically, the electronic request in response to determining that the set of auto-execution criteria have been met.

20. The non-transitory machine-readable medium of claim 19, wherein the set of auto-execution criteria includes at least one of the approver credential being on a list of preapproved approver credentials associated with auto-execution or a data operation indicated by the electronic request being on a list of preapproved data operations associated with auto-execution.
